(19) United States
(12) Patent Application Publication
(10) Pub. No.: US 2018/0139360 A1
(43) Pub. Date: May 17, 2018

(54) METHOD AND DEVICE FOR PROCESSING COLOR IMAGE DATA REPRESENTING COLORS OF A COLOR GAMUT

(71) Applicant: THOMSON Licensing, Issy-les-Moulineaux (FR)

(72) Inventors: Edouard FRANCOIS, Bourg des Comptes (FR); Patrick LOPEZ, Livré sur Changeon (FR); Sebastien LASSERRE, Thorigné Fouillard (FR)

(21) Appl. No.: 15/571,901

(22) PCT Filed: May 12, 2016
(86) PCT No.: PCT/EP2016/060613

§ 371 Date: Nov. 6, 2017

(30) Foreign Application Priority Data
May 18, 2015 (EP) 15305743.5
Sep. 15, 2015 (EP) 15306416.7
Sep. 29, 2015 (EP) 15306534.7

(51) Int. Cl. H04N 1/60; H04N 19/186

(52) U.S. Cl. CPC H04N 1/6061; H04N 19/186; H04N 1/6008; H04N 1/6066

(57) ABSTRACT

The present disclosure generally relates a method and device for processing color image data. The method comprises a color gamut mapping in the course of which a color image data (CID), represented by a first 2D point (A) belonging to a representation of the original color gamut in a chromaticity diagram, is mapped to a mapped color image data (MCID) of a target color gamut (TCG), the mapped color image data of the target color gamut (TCG) being represented by a second 2D point (B) belonging to a representation of the target color gamut (TCG) in the chromaticity diagram, wherein the color gamut mapping comprises: —obtaining (100) a representation of a preserved color gamut (PCG) in the chromaticity diagram by applying an homothety either to the original color gamut or to the target color gamut; —checking (110) if said first 2D point is located outside the representation of the preserved color gamut (PCG); and —when said first 2D point is located outside the representation of the preserved color gamut (PCG), moving (300) said first 2D point so that it belongs to the representation of the target color gamut (TCG), the second 2D point being then equal to the moved first 2D point. The disclosure relates also to a method and device for encoding/decoding color image data.

### 1. FIELD

The present disclosure generally relates to color gamut mapping and inverse color mapping of color image data.

### 2. BACKGROUND

The present section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the following, a picture contains one or several arrays of color image data in a specific picture/video format which specifies all information relative to the pixel values of a picture (or a video) and all information which may be used by a display and/or any other device to visualize and/or decode a picture (or video) for example. A picture comprises at least one component, in the shape of a first array of color image data, usually a luma (or luminance) component, and, possibly, at least one other component, in the shape of at least one other array of color image data, usually a color component. Or, equivalently, the same information may also be represented by a set of arrays of color image data, such as the traditional tri-chromatic RGB representation.

A color image data is represented by a vector of C values, where C is the number of components. Each value of a vector is represented with a number of bits which is linked to the maximal dynamic range of the color image data.

A dynamic range is defined as the ratio between the minimum and maximum luminance of picture/video signal. The luminance (or brightness) is commonly measured in candela per square meter (cd/m²) or nits and corresponds to the luminous intensity per unit area of light travelling in a given direction. Dynamic range is also measured in terms of ‘f-stop’, where one f-stop corresponds to a doubling of the signal dynamic range. High Dynamic Range (HDR) generally corresponds to more than 16 f-stops. Levels in between 10 and 16 f-stops are considered as ‘Intermediate’ or ‘Extended’ dynamic range (EDR).

Current video distribution environments provide Standard Dynamic Range (SDR), typically supporting a range of brightness (or luminance) of around 0.1 to 100 cd/m², leading to less than 10 f-stops. The intent of HDR color image data is therefore to offer a wider dynamic range, closer to the capacities of the human vision.

Another aspect for a more realistic experience is the color dimension, which is conventionally defined by a color gamut. A color gamut is a certain set of colors. The most common usage refers to a set of colors which can be accurately represented in a given circumstance, such as within a given color space or by a certain output device.

A color gamut is defined by its color primaries and its white point.

Since the human eye has three types of color sensors that respond to different ranges of wavelengths, a full plot of all visible colors is a three-dimensional figure. However, the concept of color can be divided into two parts: brightness and chromaticity. For example, the color white is a bright color, while the color grey is considered to be a less bright version of that same white. In other words, the chromaticity of white and grey are the same while their brightness differs.

The CIE XYZ color space was deliberately designed so that the Y parameter was a measure of the brightness or luminance of a color. The chromaticity of a color was then specified by the two derived parameters x and y, two of the three normalized values which are functions of all three tristimulus values X, Y, and Z:

$$x = \frac{X}{X + Y + Z}$$

$$y = \frac{Y}{X + Y + Z}$$

$$z = \frac{Z}{X + Y + Z} = 1 - x - y$$

The derived color space specified by x, y, and Y is known as the CIE xyY color space and is widely used to specify colors in practice.

The X and Z tristimulus values can be calculated back from the chromaticity values x and y and the Y tristimulus value:

$$X = \frac{Y}{y} x$$

$$Z = \frac{Y}{y} ( 1 - x - y )$$

FIG. 1 shows a CIE 1931 xy chromaticity diagram obtained as explained above.

The outer curved boundary SL is the so-called spectral locus, (delimited by the tongue-shaped or horseshoe-shaped area), representing the limits of the natural colors.

Note that a chromaticity diagram is a tool to specify how the human eye will experience light with a given spectrum. It cannot specify colors of objects (or printing inks), since the chromaticity observed while looking at an object depends on the light source as well.

It is usual that a representation of a color gamut in a chromaticity diagram is delimited by a polygon joining the color primaries defined in a chromaticity diagram. The polygon is usually a triangle because the color gamut is usually defined by three color primaries, each represented by a vertex of this triangle.

An example of a representation of an Original Color Gamut (OCG), and a representation of a Target Color Gamut (TCG) in the CIE 1931 xy chromaticity diagram are given by M. Pedzisz (2014). Beyond BT.709, SMPTE Motion Imaging Journal, vol. 123, no. 8, pp 18-25.

For example, the OCG corresponds to the BT.2020 color gamut, compatible with incoming UHDTV devices, while the TCG corresponds to the BT.709 color gamut compatible with existing HDTV devices. Such a TCG is usually said the Standard Color Gamut (SCG). As illustrated by FIG. 1, each color of a color gamut, here OCG, and thus each color image data representing a color of this color gamut, is represented by a 2D point A in this chromaticity diagram, and mapping a color of the OCG to a color of a different target color gamut TCG involves moving the 2D point A to a 2D point B representing a color of the TCG.

For example, mapping colors of the standard color gamut, typically BT.709, to the colors of a wider color gamut, typically BT. 2020, aims to provide, to the end-user, colors closer to real life, as the BT.2020 triangle comprises more natural colors than the BT.709 triangle.

Distributing OCG color image data, i.e. color image data representing a color of an OCG, involves the problem of backward compatibility with legacy devices which support only SCG color image data, i.e. color image data representing a color of a SCG. This is the so-called problem of color gamut incompatibility.

More precisely, distributing OCG color image data involves the co-existence in a same stream of an OCG, e.g. BT.2020, version of the color image data and a SCG, e.g. BT.709, version of those color image data.

This requires at some point a color gamut mapping from a first color gamut to a second color gamut should be performed without destroying the ability to restore the first color gamut version of the color image data from the second color gamut version of said color image data, i.e. in simple words, an invertible color gamut mapping.

### 3. SUMMARY

The following presents a simplified summary of the disclosure in order to provide a basic understanding of some aspects of the disclosure. This summary is not an extensive overview of the disclosure. It is not intended to identify key or critical elements of the disclosure. The following summary merely presents some aspects of the disclosure in a simplified form as a prelude to the more detailed description provided below.

The disclosure sets out to remedy at least one of the drawbacks of the prior art with a method for processing color image data representing colors of an original color gamut. The method comprises a color gamut mapping in the course of which a color image data, represented by a first 2D point belonging to a representation of the original color gamut in a chromaticity diagram, is mapped to a mapped color image data of a target color gamut, the mapped color image data of the target color gamut being represented by a second 2D point belonging to a representation of the target color gamut in the chromaticity diagram. The color gamut mapping comprises:
obtaining a representation of a preserved color gamut in the chromaticity diagram by applying an homothety either to the original color gamut or to the target color gamut;
checking if said first 2D point is located outside the representation of the preserved color gamut; and
when said first 2D point is located outside the representation of the preserved color gamut, moving said first 2D point so that it belongs to the representation of the target color gamut, the second 2D point being then equal to the moved first 2D point.

According to another of its aspects, the present principles relate to a method for processing color image data, comprising an inverse color gamut mapping in the course of which a mapped color image data, represented by a second 2D point belonging to a representation of a target color gamut in a chromaticity diagram, is inverse mapped to said color image data, the inverse mapped color data of the original color gamut being represented by a first 2D point belonging to a representation of the original color gamut in the chromaticity diagram. The method further comprises:
obtaining a representation of a preserved color gamut in the chromaticity diagram by applying an homothety either to the original color gamut or to the target color gamut;
checking if said second 2D point is located outside the outside the representation of the preserved color gamut; and
when said second 2D point is located outside the representation of the preserved color gamut, moving said second 2D point so that it belongs to the representation of the original color gamut, the first 2D point being then equal to the moved second 2D point.

According to another of its aspects, the present principles relate to a method for encoding color image data, wherein the color image data are pre-processed according to the previous method.

According to another of its aspects, the present principles relate to a method for decoding color image data, wherein the color image data are post-processed according to the previous method.

According to other of its aspects, the disclosure relates to a device comprising a processor configured to implement one of the above methods, a computer program product comprising program code instructions to execute the steps of one of the above method when this program is executed on a computer, a processor readable medium having stored therein instructions for causing a processor to perform at least the steps of one of the above method, and a non-transitory storage medium carrying instructions of program code for executing steps of one of the above method when said program is executed on a computing device.

The specific nature of the disclosure as well as other objects, advantages, features and uses of the disclosure will become evident from the following description of embodiments taken in conjunction with the accompanying drawings.

### 4. BRIEF DESCRIPTION OF DRAWINGS

In the drawings, an embodiment of the present disclosure is illustrated. It shows:

FIG. 1 depicts some example of color gamuts represented in the CIE 1931 xy chromaticity diagram;

FIG. 2 shows a block diagram of the steps of a method for processing a color image data comprising a color gamut mapping in accordance with an example of the present principles;

FIG. 3 shows a block diagram of the steps of a method for processing a color image data comprising an inverse color gamut mapping in accordance with an example of the present principles;

FIG. 4 illustrates BT.709 and P3D65 color primaries and white point;

FIG. 5 shows examples of OCG and TCG represented in the CIE 1931 xy chromaticity diagram;

FIG. 6 a block diagram of the steps of a color gamut mapping in accordance with an embodiment of the method of FIG. 2;

FIG. 7 illustrated the built of a centroid;

FIG. 8 illustrates the built of the preserved color gamut;

FIG. 9 shows an example of a 2D point A, and corresponding segments [BO,GO], [BT,GT], [BP,GP];

FIG. 10 illustrates the derivation of intersection points I_{O}, I_{T} and I_{P},

FIG. 11 shows a block diagram of the steps of an inverse color gamut mapping in accordance with an embodiment of the method of FIG. 3;

FIG. 12 shows examples of OCG, PCG and TCG represented in the CIE 1931 xy chromaticity diagram.

FIGS. 13a-b show an embodiment of the step 300 of the method;

FIG. 14 depicts an example of an intermediate color gamut in according with an example of the present principles;

FIGS. 15a-b show an embodiment of the step 300 of the method;

FIGS. 16a-b show an embodiment of the step 300 of the method;

FIG. 17 illustrates a clipping of a color when the color gamuts are represented in a chromaticity diagram in accordance with an embodiment of the disclosure;

FIG. 18 shows an example of an architecture of a device in accordance with an embodiment of the disclosure;

FIG. 19 shows two remote devices communicating over a communication network in accordance with an embodiment of the disclosure;

FIG. 20 shows an example of SEI message syntax that can be conveyed as metadata with a stream and that embeds parameters useful to perform the inverse color gamut mapping;

FIG. 21 shows an example of SEI message syntax that can be conveyed as metadata with a stream and that embeds parameters useful at the decoder side to perform the method for processing color image data and more precisely to perform the inverse color gamut mapping; and

FIG. 22 shows an example of parameter values.

Similar or same elements are referenced with the same reference numbers.

### 6. DESCRIPTION OF EMBODIMENTS

The present disclosure will be described more fully hereinafter with reference to the accompanying figures, in which embodiments of the disclosure are shown. This disclosure may, however, be embodied in many alternate forms and should not be construed as limited to the embodiments set forth herein. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure as defined by the claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Although some of the diagrams include arrows on communication paths to show a primary direction of communication, it is to be understood that communication may occur in the opposite direction to the depicted arrows.

Some embodiments are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “one embodiment” or “an embodiment” means that a particular feature, structure, or characteristic described in connection with the embodiment can be included in at least one implementation of the disclosure. The appearances of the phrase “in one embodiment” or “according to an embodiment” in various places in the specification are not necessarily all referring to the same embodiment, nor are separate or alternative embodiments necessarily mutually exclusive of other embodiments.

Reference numerals appearing in the claims are by way of illustration only and shall have no limiting effect on the scope of the claims.

While not explicitly described, the present embodiments and variants may be employed in any combination or sub-combination.

The disclosure is described for encoding/decoding color image data and thus extends to the encoding/decoding of a picture because the color image data represents the pixels values, and to sequence of pictures (video) because each picture of the sequence is sequentially encoded/decoded.

Moreover, the color image data are considered as expressed in a 2D xyY color space (or any other equivalent 2D color space). Consequently, when the color image data are expressed in another color space, for instance in an RGB color space, or in the CIE 1931 XYZ color space, or a differential coding color space such as YCbCr or YDzDx, conversion processes are applied to these color data.

In the following, the following rules for notations are applied:
the coordinates of a vector or a point in a 3D RGB color space are written in small font. For instance, (rₖ,gₖ,bₖ) corresponds to the three coordinates of a color sample K in a 3D RGB color space.
In the 3D XYZ color space, caps font is used to keep the distinction with the 2D xyY color space where small font is used. For instance, (Xₖ,Yₖ,Zₖ) are the coordinates of a color sample K in the 3D XYZ color space.
In the 2D xyY color space, small font is used. For instance, (x_{A},y_{A}) are the coordinates of the 2D point A in the 2D xyY color space.
The Red, Green or Blue color primaries in a color space are written in caps font. For instance, red primary in the 3D RGB color space of an original color gamut OCG is written R_{O}.
a vector linking two 2D points A and B in the 2D xyY color space is noted AB.
the distance between two 2D points A and B is noted |AB|.
the line passing through 2D points A and B is noted (AB)
the symbols ‘.’ or ‘x’ are used for the scalar multiplication.

In the following, the tristimulus (r,g,b), expressed in the 3D RGB color space of the OCG are used. Conversion of this tristimulus into 2D xyY coordinates system applies to represent the coordinates of a 2D point in the chromaticity diagram. Such tristimulus refer to a 3D RGB color space but the (r,g,b) tristimulus may also refer to tristimulus if any other color space, such as XYZ, YCbCr, YDzDx for example. In the following, for a given color sample co, its coordinates (r_{co},g_{co},b_{co}) in the 3D RGB color space of the OCG as well as the coordinates (x_{co},y_{co}) in the 2D xyY color space may be used, depending on the considered process applied to the color sample co.

Note that a 3D RGB color space depends on the color primaries and white point. Hence, there is one 3D RGB color space of the OCG or one 3D RGB color space of a target color gamut (TCG). On the contrary the XYZ color space is universal: it does not depend on color primaries or white point. A color sample co has different coordinate values in these different color spaces. Converting coordinate values from one 3D RGB color space (e.g. 3D RGB color space of the OCG) to another 3D RGB color space (e.g. 3D RGB color space of a preserved color gamut (PCG)) generally involves multiplication by 3×3 matrices.

According to an exemplary embodiment, the disclosure relates to a method for processing color image data representing colors of an original color gamut OCG. The method comprises a color gamut mapping in the course of which each color image data CID to be mapped is represented by a first 2D point A belonging to a representation of the OCG in a chromaticity diagram. Said color image data is then mapped to a mapped color image data MCID representing a color of a target color gamut TCG, each color of said TCG being represented by a second 2D point B belonging to a representation of said TCG in the chromaticity diagram.

As mentioned before, one of the advantages of the disclosure is to provide a color gamut mapping that can be invertible and as far as possible of limited complexity to be implementable on hardware or FPGA platforms used for instance in Set-top-boxes or blu-ray players for example. In addition it has to preserve as much as possible the color in the Target Color Gamut (TGC).

The principle of the color gamut mapping, according to an embodiment of the disclosure, is to define an homothetic ‘preserved color gamut’ (PCG) inside the TCG, that is typically the Standard Color Gamut (SCG). Next, any color image data representing a color of this PCG is then not modified by the color gamut mapping and any color image data representing a color located outside the PCG is then processed (shrunk) as explained below such that the mapped color image data MCID represents a color of the TCG.

A homothety is a transformation of an affine space determined by a point called its centre (or centroid) and a nonzero number called a scaling factor (or ratio).

According to an embodiment of the disclosure, the CIE 1931 xyY chromaticity diagram is used. However, the disclosure extends to any other chromaticity diagram such as CIE Luv (2D coordinate systems define by u and v components), or CIE Lab (2D coordinate systems define by a and b components).

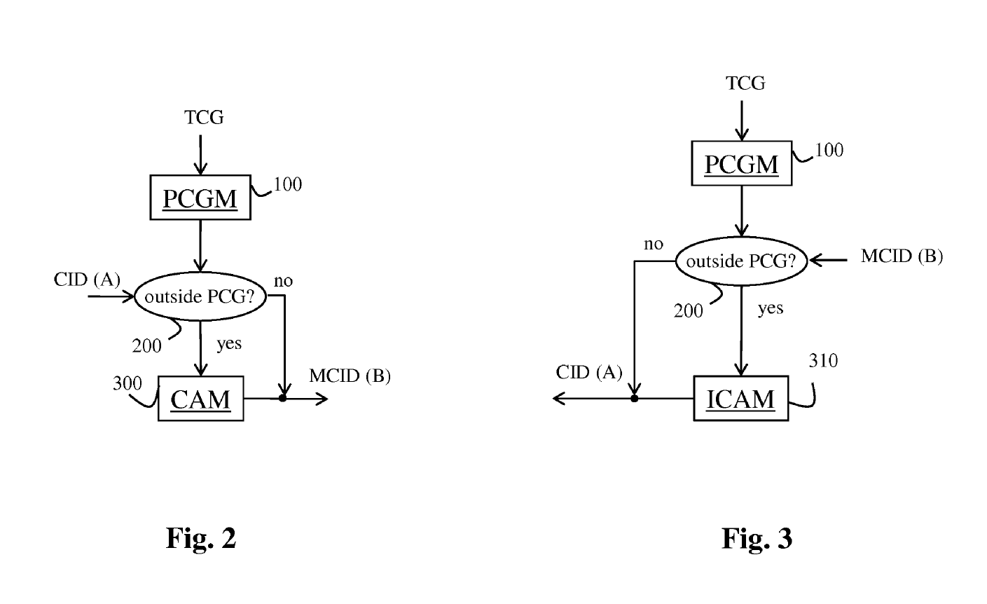

FIG. 2 shows a block diagram of the steps of method for processing color image data comprising a color gamut mapping in accordance with an example of the present principles.

In step 100, a module PCGM obtains a representation of a preserved color gamut PCG in the chromaticity diagram by applying an homothety either to the original color gamut OCG or to the target color gamut TCG.

In step 200, a module checks if said first 2D point A is located outside the representation of the preserved color gamut PCG.

In step 300, when said first 2D point A is located outside the representation of the preserved color gamut PCG, a module CAM moves said first 2D point A so that it belongs to the representation of the target color gamut TCG. Note, the second 2D point B is then equal to the moved first 2D point.

According to another of its aspects, the disclosure further relates to an inverse color gamut mapping, i.e. the inverse of the color gamut mapping described above.

Thus, the method for processing color image data representing colors of a color gamut may comprises either the color gamut mapping, or the inverse color gamut mapping or both.

FIG. 3 shows a block diagram of the steps of a method for processing a color image data comprising an inverse color gamut mapping in accordance with an example of the present principles.

The principle of the inverse color gamut mapping is to retrieve the first 2D point A representing the color image data CID from the second 2D point B that represents the mapped color image data. Note the first 2D point A belongs to the representation of the OCG and the second 2D point B belongs to the representation of the TCG.

The method for processing a color image data comprises an inverse color gamut mapping in the course of which mapped color image data, represented by a second 2D point belonging to a representation of a target color gamut in a chromaticity diagram, is inverse mapped to said color image data, the inverse mapped color data of the original color gamut being represented by a first 2D point belonging to a representation of the original color gamut in the chromaticity diagram.

In step 100, a module PCGM obtains a representation of a preserved color gamut PCG in the chromaticity diagram by applying a homothety either to the original color gamut or to the target color gamut.

In step 200, a module checks if said second 2D point B is located outside the representation of the preserved color gamut PCG.

In step 310, when said second 2D point B is located outside the representation of the preserved color gamut PCG, a module ICAM moves said second 2D point B so that it belongs to the representation of the original color gamut OCG, the first 2D point A being then equal to the moved second 2D point B.

### First Embodiment

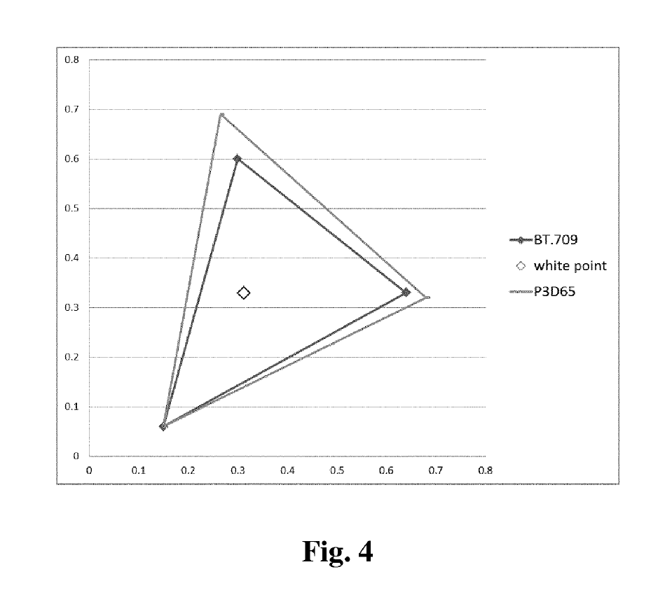

There is one specific case of color gamut mapping that is of high interest for the incoming deployment of wide color gamut content: the conversion from P3D65 color gamut to BT.709 color gamut (FIG. 4). The color primaries and white point of these two color gamuts are given in the following table, in the xyY color space.

| | BT.709 | | P3D65 | |
|---|---|---|---|---|
| xW, yW | 0.3127 | 0.329 | 0.3127 | 0.329 |
| xR, yR | 0.64 | 0.33 | 0.68 | 0.32 |
| xG, yG | 0.3 | 0.6 | 0.265 | 0.69 |
| xB, yB | 0.15 | 0.06 | 0.15 | 0.06 |

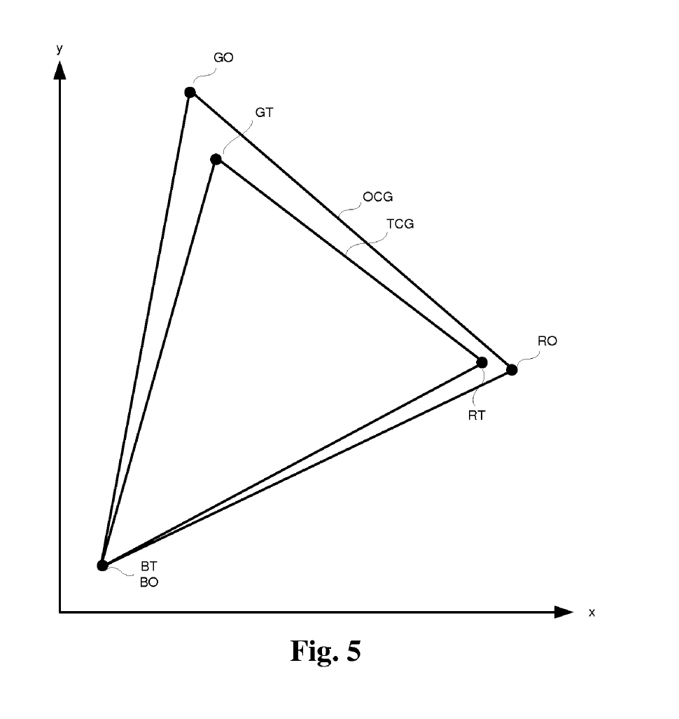

In the following, as illustrated in FIG. 5, the primaries of the color gamut OCG and TCG are noted:
RT=(xRT,yRT) the red color primary of the TCG in the xyY color space
GT=(xGT,yGT) the green color primary of the TCG in the xyY color space
BT=(xBT,yBT) the blue color primary of the TCG in the xyY color space
RO=(xRO,yRO) the red color primary of the OCG in the xyY color space
GO=(xGO,yGO) the green color primary of the OCG in the xyY color space
BO=(xBO,yBO) the blue color primary of the OCG in the xyY color space

In the case where TCG is BT.709 and OCG is P3D65, the points BT and BO are identical.

We also note:
A=(xA,yA) a point (in xyY color space) that has to be mapped
B=(xB,yB) the mapped point (in xyY color space) of point A.

In the specific case of color gamut mapping from P3D65 to T.709 color gamuts, it can be noticed that one of the three color primaries of the two color gamuts is identical, namely the blue primary. This property is exploited in said first embodiment to derive an optimal gamut mapping.

Generally speaking, said first embodiment of the present principles relates to a method for processing a color image data CID, comprising a color gamut mapping in the course of which each of the color image data CID, represented by a 2D point A belonging to a representation of an original color gamut OCG in a chromaticity diagram, is mapped to a mapped color image data MCID of a target color gamut TCG. Each color gamut is represented by a triangle defined by three 2D points representing three color primaries of in a chromaticity diagram, and each color gamut defined in such chromaticity diagram has a same primary in common as illustrated in FIG. 5.

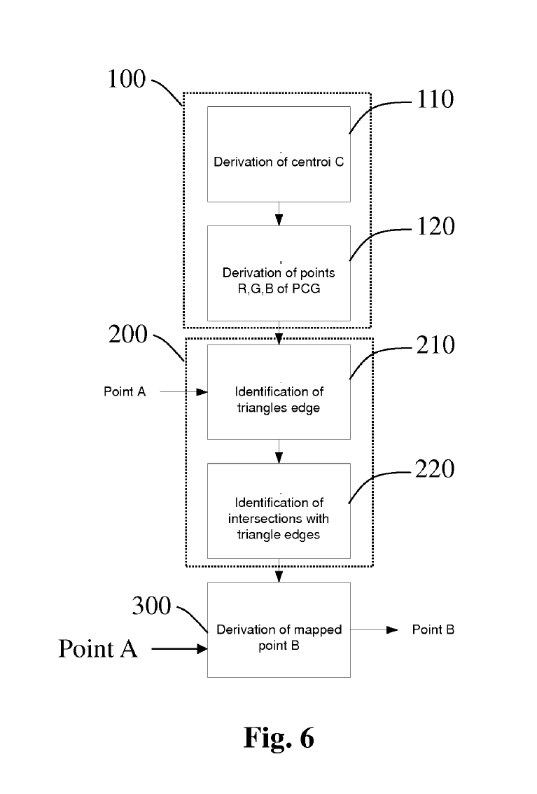

In step 100, as illustrated in FIG. 6, a representation of the preserved color gamut PCG in the chromaticity diagram is obtained as follows:

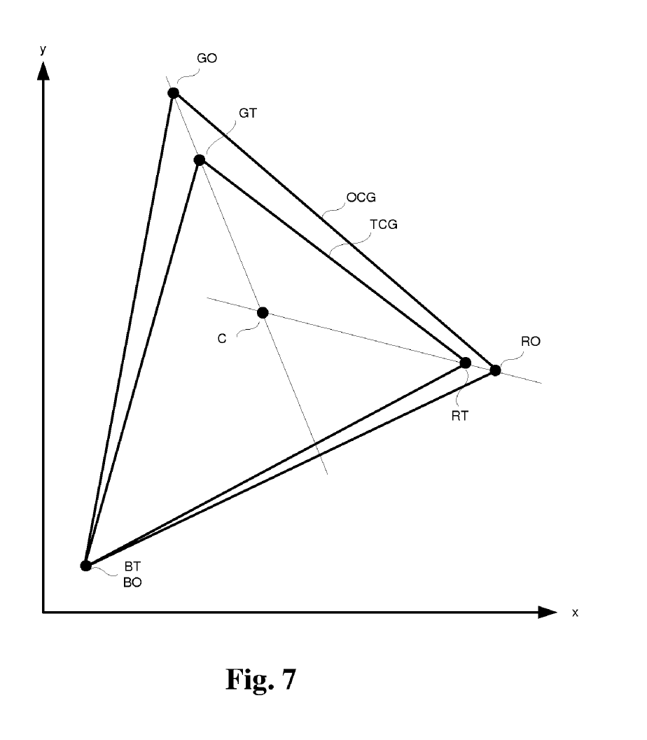

In step 110, as illustrated in FIG. 7, a centroid C is determined as being a 2D intersection point between a line joining a 2D point GO representing a first primary of the original color gamut OCG with a 2D point GT representing the corresponding first primary of the target color gamut (TCG) and a line joining a 2D point RO representing a second primary of the original color gamut RO with a 2D point RT representing the corresponding second primary of the target color gamut (TCG).

The centroid may be computed as follows:

xC=−(bR−bG)/(aR−aG)

yC=aR*xC+bR

with

aR=(yRT−yRO)/(xRT−xRO)bR=yRT−aR*xRT

aG=(yGT−yGO)/(xGT−xGO)bG=yGT−aG*xGT

In step 120, a representation of a preserved color gamut in the chromaticity diagram is obtained by applying an homothety, whose the center is said determined centroid C, to said first and second primaries either of the target color gamut or of the original color gamut by using at least one scaling factor lower than one.

For example a first scaling factor f_{R} and a second scaling factor f_{S} of an homothety are obtained from either a local or remote memory. Said first and second scaling factors are lower than one and are used, in collaboration with said first and second primaries of either the target color gamut TCG or the original color gamut OCG, to define a representation of a preserved color gamut PCG in the chromaticity diagram.

These scaling factors may be input parameters that enable to control the performance of the color gamut mapping. They may be signaled as metadata in a stream F and transmitted in order to perform the inverse color gamut mapping.

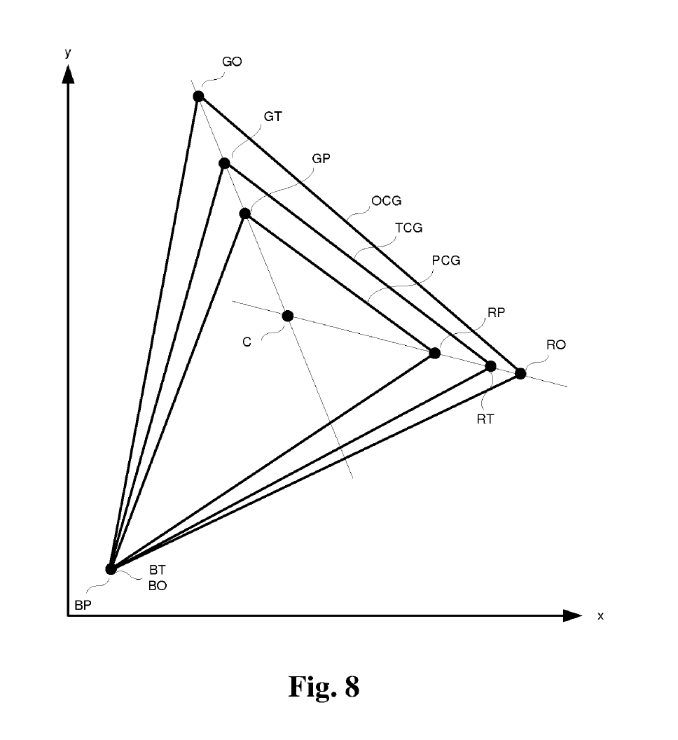

As illustrated in FIG. 8, the color primaries of the PCG are defined from the color primaries of the TCG as follows:
BP is equal to BT (and to BO)
RP is derived by homethety of factor fR of point RT with centroid C:

xRP=xC+fR.(xRT−xC)

yRP=yC+fR.(yRT−yC)
GP is derived by homethety of factor fG of point GT with centroid C:

xGP=xC+fG.(xGT−xC)

yGP=yC+fG.(yGT−yC)

Alternatively, the color primaries of the PCG are defined from the color primaries of the OCG as follows:
BP is equal to BO (and to BT)
RP is derived by homethety of factor fR of point RO with centroid C:

xRP=xC+fR.(xRO−xC)

yRP=yC+fR.(yRO−yC)
GP is derived by homethety of factor fG of point GO with centroid C:

xGP=xC+fG.(xGO−xC)

yGP=yC+fG.(yGO−yC)

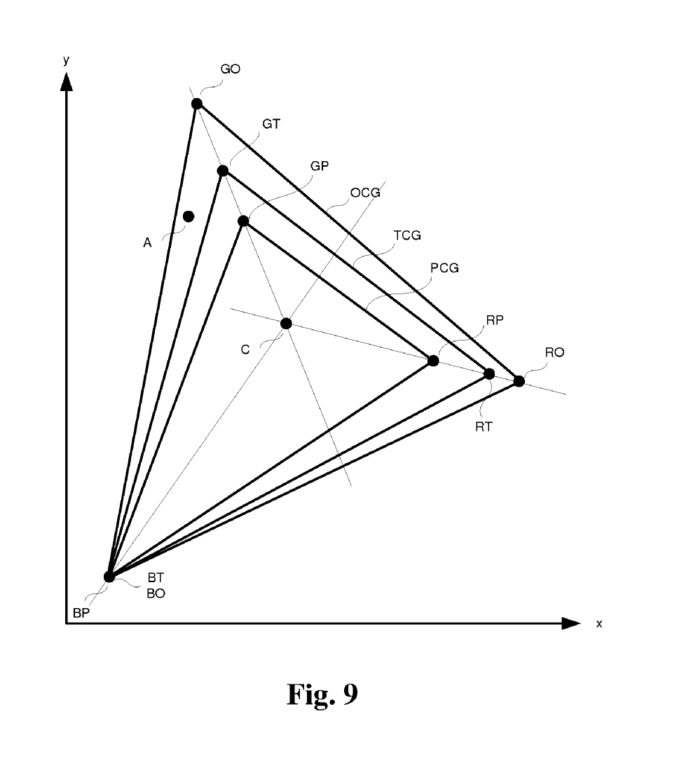

In step 200, checking if said first 2D point A is located outside the representation of the preserved color gamut (PCG) comprises identifying (step 210) which of the edges of the representation of the target color gamut TCG, of the preserved color gamut PCG and of the original color gamut OCG, is the closest edge of the first 2D point A, as illustrated in FIG. 9.

For that, we consider the three lines
(C,RT) defined by the equation y=aR.x+bR, with aR,bR already defined above
(C,GT) defined by the equation y=aG.x+bG, with aG,bG already defined above
(C,BT) defined by the equation y=aB.x+bB, with aB,bB defined as follows:

aB=(yBT−yC)/(xBT−xC)bB=yBT−aB*xBT

Let P1O, P2O of the OCG, P1T, P2T of the TCG and P1P, P2P of the PCG be the points which segment A corresponds to.

The test to identify these points can be done as follows. The three following values are computed:

T_OR=yA−aR.xA−bR

T_OG=yA−aG.xA−bG

T_OB=yA−aB.xA−bB

### Then:

If T_OR>=0 and T_OG>=0, P1X=RX and P2X=GX
Otherwise if T_OG<0 and T_OB>0, P1X=GX and P2X=BX
Otherwise if T_OG<0 and T_OB>0, P1X=BX and P2X=RX
   With X being either T, O or P.

For instance in the figure below, the segment [P1T,P2T] is [BT,GT], the segment [P1O,P2O] is [BO,GO], and the segment [P1 P,P2P] is [BP,GP].

The step 200 further comprises a step 220 in which is determined an intersection 2D point between a line joining the first 2D point A and the centroid C and each identified edge.

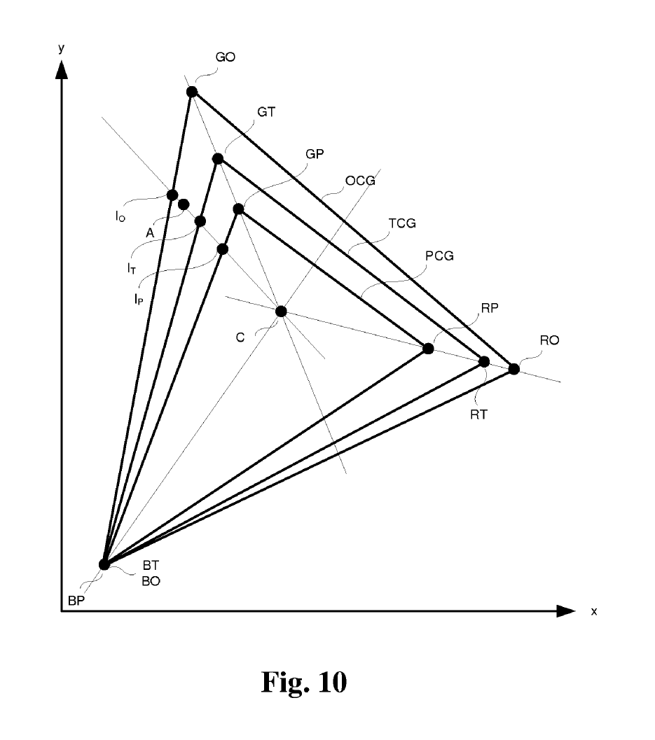

As illustrated in FIG. 10, the intersection I_{T} of line (C,A) with segment [BT,GT], the intersection I_{O} of line (C,A) with segment [BO,GO], and the intersection I_{P} of line (C,A) with segment [BP,GP] are determined. This also enables identifying the relative length of segments [C,I_{P}], [C,I_{T}] and [C,I_{O}]. The distance ratio mO=|C I_{O}|/|C A| can be derived as follows:

mO=[xP2O.(yP1O−yP2O)−yP2O.(xP1O−xP2O)]/[xA.(yP1O−yP2O)−yA.(xP1O−xP2O)]

The distance ratio mT=|C I_{T}|/|C A| can be derived as follows:

mT=[xP2T.(yP1T−yP2T)−yP2T.(xP1T−xP2T)]/[xA.(yP1T−yP2T)−yA.(xP1T−xP2T)]

The distance ratio mP=|C I_{P}|/|C A| can be derived as follows:

mP=[xP2P.(yP1P−yP2P)−yP2P.(xP1P−xP2P)]/[xA.(yP1P−yP2P)−yA.(xP1P−xP2P)]

where the coordinates are expressed with point C as origin.

The coordinates of the points I_{O}, I_{T} and I_{P} are derived as follows:

xIO=xC+mO.(xA−xC)

yIO=yC+mO.(yA−yC)

xIT=xC+mT.(xA−xC)

yIT=yC+mT.(yA−yC)

xIP=xC+mP.(xA−xC)

yIP=yC+mP.(yA−yC)

In step 300 (FIG. 2), when said first 2D point A is located outside the representation of the preserved color gamut PCG, moving said first 2D point so that it belongs to the representation of the target color gamut TCG, the second 2D point being then equal to the moved first 2D point.

According to an embodiment, a first 2D point A is considered as being located outside the representation of the preserved color gamut PCG if the ratio, defined by the distance separating the centroid C and the intersection 2D point P over the distance separating the centroid and the first 2D point A, is lower than or equal to 1.

For example, if mP is lower than or equal to 1, A is inside the PCG. In this case, the 2D point A is not modified, and the 2D point B is set equal to the 2D point A. Otherwise, the 2D point A is moved (shrinked) to a 2D point B different from the 2D point A.

According to an embodiment of the step 300, illustrated in FIG. 10, moving a first 2D point A so that it belongs to the representation of the target color gamut TCG follows the following rules:
if A is equal to I_{O}, B is set equal to I_{T}
if A is equal to I_{P}, B is set equal to I_{P}

The moved first 2D point A, i.e. the 2D point B belonging to the TCG can be obtained as follows using the 2D intersection point 10 as the reference point:

C B=C I_{O}. ρ1(|C A|/|C I_{O}|)=C I_{O}. ρ1(1/mO)

where the monotonic increasing function ρ1(.) satisfies the following conditions:

ρ1(|C I_{O}|/|C I_{O}|)=|C I_{T}|/|C I_{O}|

ρ1(|C I_{P}|/|C I_{O}|)=|C I_{P}|/|C I_{O}|

or equivalently:

ρ1(1)=mT/mO

ρ1(mP/mO)=mP/mO

For instance, the model of the monotonic increasing function ρ1(.) is given by:

ρ1(r)=u.r+v

with u=(mT−mP)/(mO−mP) and v=mT/mO u.

According to another example, the model of the monotonic increasing function ρ1(.) is given by:

ρ1(r)=u.log(r)+v

with u=(mP−mT)/mO/log(mP/mO) and v=mT/mO

Similar equations can be simply derived by using as reference points I_{P} or I_{T}.

Finally the 2D point B is derived as follows:
the distance ratio r′=|C B|/|C I_{O}| is derived as

r′=ρ1(min(1,1/mO))
The clipping min(1, 1/mO) is applied to force point B to be inside the TCG even if A is outside the OCG (in which case 1/mO is larger than 1).
The point B is derived as:

xB=xC+r′.(xIO−xC)

yB=yC+r′.(yIO−yC)

The monotonic function may be signaled as metadata in a stream F and transmitted in order to perform the inverse color gamut mapping.

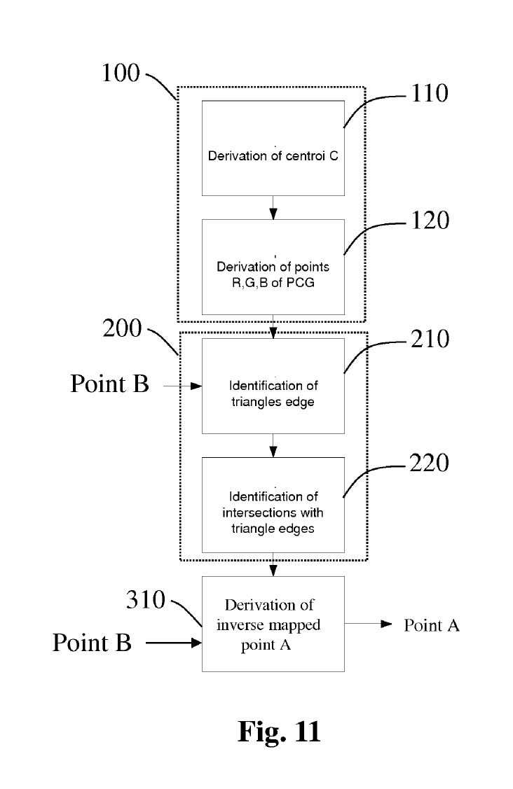

FIG. 11 shows a block diagram of the steps of an inverse color gamut mapping in accordance with an embodiment of the method of FIG. 3.

In step 100, a centroid C is determined (step 110) and a representation of a preserved color gamut in the chromaticity diagram is obtained (step 120) as described above in relation with FIG. 6.

These scaling factors may be input parameters that enable to control the performance of the inverse color gamut mapping. They may be obtained as metadata from a stream F.

In step 200, checking if said first 2D point A is located outside the representation of the preserved color gamut (PCG) comprises identifying (step 210) which of the edges of the target color gamut TCG, of the preserved color gamut PCG and of the original color gamut OCG, is the closest edge of the 2D point B. Such identifying is similar to the identifying as explained above in relation with FIG. 9.

The step 200 further comprises the step 220 in which is determined an intersection 2D point between a line joining the second 2D point B and the centroid C and each identified edge as explained above in relation with FIG. 10.

In step 310 (FIG. 3), when said 2D point B is located outside the representation of the preserved color gamut PCG, moving said 2D point B so that it belongs to the representation of the original color gamut OCG, the first 2D point A being then equal to the moved 2D point B.

According to an embodiment, a sec and 2D point B is considered, as explained above, as being located outside the representation of the preserved color gamut PCG if the ratio, defined by the distance separating the centroid and the intersection 2D point relative to the representation of the preserved color gamut PCG over the distance separating the centroid and the second 2D point, is lower than or equal to 1.

For, if mP is lower than or equal to 1, B is inside the PCG. In this case, B is not modified, and point A is set equal to B. Otherwise, the point B is moved (stretched) to point A different from B.

The basic rules of the mapping are as follows:
if B is equal to I_{T}, A is set equal to I_{O}
if B is equal to I_{P}, A is set equal to I_{P}

The moved 2D point B, i.e. the 2D point A belonging to the OCG can be obtained as follows using the 2D intersection point IO as the reference point:

C A=C I_{O}. ρ1⁻¹(|C B|/|C I_{O}|)=C I_{O}. ρ1⁻¹(1/mO)

where the monotonic increasing function ρ1⁻¹ (.) is the inverse of the function ρ1(.).
ρ1⁻¹(.) satisfies the following conditions:

ρ1⁻¹(|C I_{T}|/|C I_{O}|)=|C I_{O}|/|C I_{O}|

ρ1⁻¹(|C I_{P}|/|C I_{O}|)=|C I_{P}|/|C I_{O}|

or equivalently:

ρ1⁻¹(mT/mO)=1

ρ1⁻¹(mP/mO)=mP/mO

For instance, the model of the monotonic increasing function ρ1⁻¹ (.) is given by:

ρ1⁻¹(r)=u.r+v

with u=(mO−mP)/(mT−mP) and v=1−u.mT/mO

According to another example, the model of the monotonic increasing function ρ1⁻¹ (.) is given by:

ρ1⁻¹(r)=u.log(r)+v

with u=(mO−mP)/mO/log(mT/mP) and v=1−u.log(mT/mO)

Similar equations can be simply derived by using as reference points I_{P} or I_{T}.

Finally the 2D point A is derived as follows:
the distance ratio r′=|C A|/|C I_{O}| is derived as

r′=ρ1(1/mO)
The point A is derived as:

xA=xC+r′.(xIO−xC)

yA=yC+r′.(yIO−yC)

The monotonic function may be input parameters that enable to control the performance of the inverse color gamut mapping. They may be obtained as metadata from a stream F.

### Second Embodiment

According to this second embodiment, in step 100 of FIG. 2, a module PCGM obtains a scaling factor f_{W} and a scaling factor fₚ of an homothety H. The scaling factor f_{W} is greater than one and is used to define a representation of an intermediate color gamut ICG in the chromaticity diagram by applying the homothety H with the scaling factor f_{W} on the representation of the target color gamut TCG. The scaling factor f_{P} is lower than one and is used to define a representation of a preserved color gamut (PCG) in the chromaticity diagram by applying the homothety H with the scaling factor f_{P} on the representation of the target color gamut TCG.

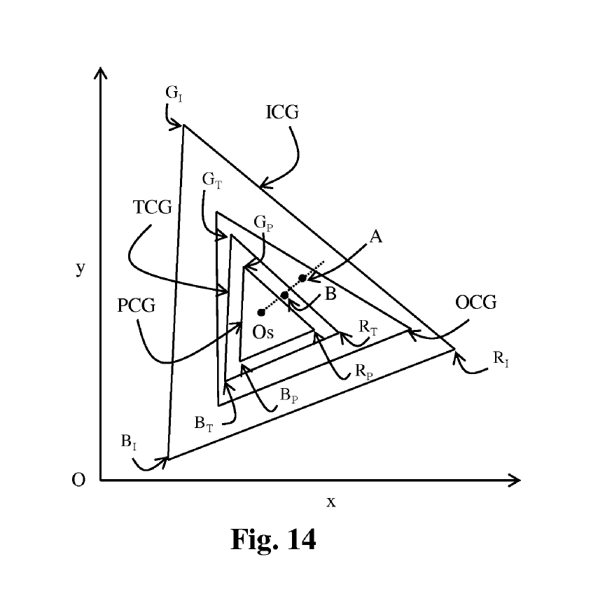

The ICG, PCG and TCG are thus homothetic as illustrated in FIG. 14.

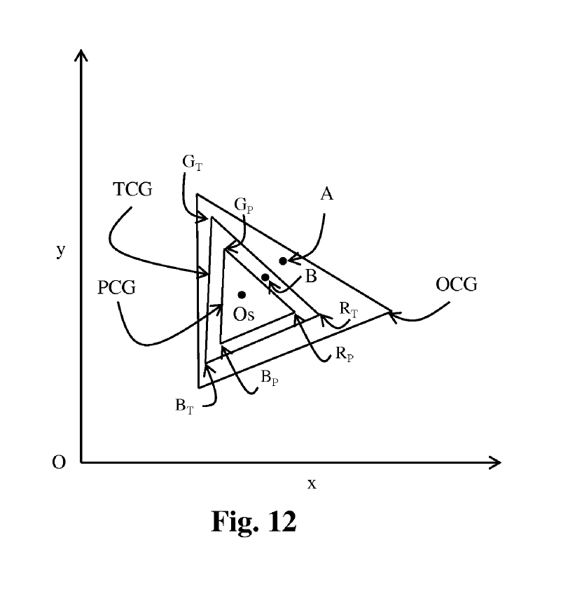

FIG. 12 shows examples of OCG, PCG and TCG represented in the CIE 1931 xy chromaticity diagram.

Each color gamut is represented, here, by a triangle whose vertices, defined as 2D points in the chromaticity diagram, represent the three color primaries defining said color gamuts. Note the white point, also used to define each color gamut, is also represented by a 2D point in the chromaticity diagram but this 2D point is not shown in FIG. 12.

When the CIE 1931 xy chromaticity diagram is considered, in step 100, the triangle representing the PCG in the chromaticity diagram is obtained from the representation of the TCG by:

O_{S}R_{P}=f_{P}. O_{S}R_{T} O_{S}G_{P}=f_{P}. O_{S}G_{T} O_{S}B_{P}=f_{P}. O_{S}B_{T}

where R_{P}, G_{P}, B_{P} are three 2D points representing the three color primaries defining the PCG in the chromaticity diagram and O_{S} is the center of the homothety H. The process would apply similarly in any other color space such as CIE Lab (using the ab 2D coordinates system) or CIE Luv (using the uv 2D coordinates system).

According to an embodiment, the center O_{S} of the homothety H is the centroid of the representation of the TCG in the chromaticity diagram given for example by:

OO_{S}=OR_{T}+OC_{T}+OB_{T}

with O is the origin of the chromaticity diagram.

According to an embodiment, the center O_{S} of the homothety H is the white point WP_{T} of the TCG.

In step 200 of FIG. 2, a module checks whether each first 2D point A is located outside the representation of the PCG in the chromaticity diagram.

In step 300, when a first 2D point A is located outside the representation of the PCG, a module CAM moves (shrinks) the first 2D point A so that it is inside the representation of the TCG.

The second 2D point B representing the mapped color image data in the chromaticity diagram is then equal to the moved first 2D point A.

FIG. 12 illustrates the color gamut mapping described in relation with FIG. 2 when the color gamuts are represented in the CIE 1931 chromaticity diagram.

A 2D point A represents, in the xyY chromaticity diagram, a color image data to be mapped. Here, the first 2D point A is located outside the triangle representing the PCG in the chromaticity diagram. Then, the first 2D point A is shrunk to belong to the triangle representing the TCG in the chromaticity diagram. The moved 2D point is a second 2D point B that represents colors included in the TCG relative to the mapped color image data.

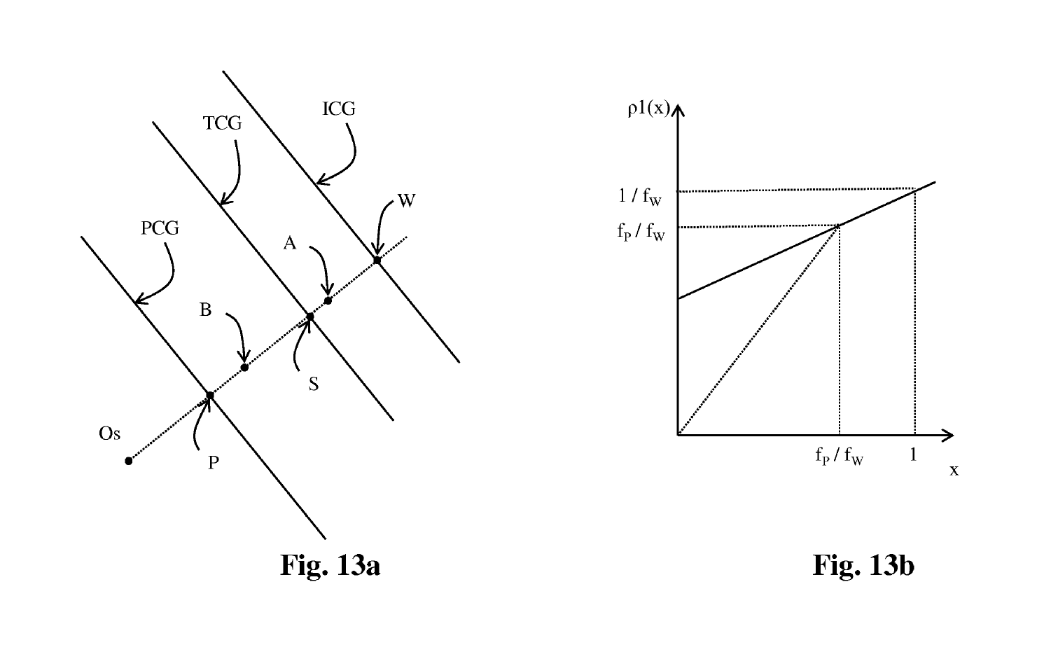

According to an embodiment of step 300, illustrated in FIGS. 13a-b, the first 2D point A is moved (shrunk) so that it belongs to the representation of the TCG as follows:

The first 2D point A is projected onto an intersection point W located on a border of a representation of an intermediate color gamut ICG, said ICG being defined by applying on a representation of the TCG the homothety H with a scaling factor f_{W} strictly greater than 1.

A representation of the ICG in the chromaticity diagram (i.e. the color primaries R_{I}, G_{I}, B_{I} defining the ICG in the chromaticity diagram) is (are) obtained by applying on a representation of a Target Color Gamut TCG (on the color primaries of TCG) an homothety H with the scaling factor f_{W}.

According to an embodiment, an information data INFOICG, that defines the border of representation of the ICG to be used, is obtained.

According to an embodiment, said information data INFOICG defines the representation of ICG and the border of the representation of the ICG is defined as follows: A border of the representation of the ICG is schematically represented by a line segment defined by two 2D points P₁ and P2 representing two ICG color primaries in the chromaticity diagram. The position of the first 2D point A in the representation of the ICG in the chromaticity diagram is given by the weighted centroid definition:

O_{S}A=a. O_{S}R_{I}+b. O_{S}G_{I}+c. O_{S}B_{I} with c=1−a−b

where a, b, and c are weighting parameters, R_{I}(x_{RI},y_{RI}), G_{I}(x_{GI},y_{GI}) and B_{I}(x_{BI},y_{BI}) are the three 2D points representing the three color primaries defining the ICG in the chromaticity diagram (FIG. 14).

This previous equation, expressed for the 2 coordinates x and y, gives the following 2 equations:

(x_{A}−x_{Os})=a.(x_{RI}−x_{Os})+b.(x_{GI}−x_{Os})+(1−a−b).(x_{BI}−x_{Os})

(y_{A}−y_{Os})=a.(y_{RI}−y_{Os})+b.(y_{GI}−y_{Os})+(1−a−b).(y_{BI}−y_{Os})

which leads to the following system, with a and b and unknown parameters:

(x_{RI}−x_{BI}). a+(x_{GI}−x_{BI}). b=(x_{A}−x_{BI})

(y_{RI}−y_{BI}). a+(y_{GI}−y_{BI}). b=(y_{A}−y_{BI})

Identifying a and b consists in solving this system of 2 equations with 2 unknowns.

Using the white point WP_{T} of the TCG instead of the centroid O_{S} would just consist in replacing in those equations O_{S} by WP_{T}.

The border of the representation of the ICG to which the 2D intersection point W belongs is then determined according to the values of the parameters a, b and c as follows:
If the value of parameter a is the minimum value (compared to the value of b and c, then the 2D intersection point W is located on the border of the representation of the ICG defined by P₁=G_{I} and P₂=B_{I};
If the value of parameter b is the minimum value (compared to the value of a and c, then the 2D intersection point W is located on the border of the representation of the ICG defined by P₁=R_{I} and P₂=B_{I};
If the value of parameter c is the minimum value (compared to the value of a and b, then the 2D intersection point W is located on the border of the representation of the ICG defined by P₁=R_{I} and P₂=G_{I}

Once the border of the representation of the ICG has been determined, the position of the 2D intersection point W on this border (defined by the points P₁ and P₂) that corresponds to the intersection of line (O_{S}A) with the segment linking P₁ and P₂ is given by:

O_{S}W=λ. O_{S}P₁+(1−λ). O_{S}P₂ (1)

where λ is a parameter value to be determined.

Moreover, the 2D intersection point W belongs to the line joining the 2D point A and the centroid O_{S}, i.e.

O_{S}W=μ. O_{S}A (2)

where μ is a real value to be defined that is greater than 1.

Replacing O_{S}W in equation (2) leads to:

λ. O_{S}P₁+(1−λ). O_{S}P₂=O_{S}A

that is

λ. P₁P₂+μ.O_{S}A=O_{S}P₂

In this process, to ease the computations, the coordinates (x_{A},y_{A}) relative to the 2D point A,(x₁, y₁) relative to the 2D point P₁, (x₂, y₂) relative to the 2D point P2 are defined with O_{S} as origin. The equation can be developed for each coordinate x and y as follows:

λ.(x₂−x₁)+μ. x_{A}=x₂

λ.(y₂−y₁)+μ.y_{A}=y₂

λ and μ are then obtained by solving this system of two equations with two unknowns λ and μ.

This gives the real values μ and λ and thus the projected 2D point intersection W on the determined border of the representation of the ICG in the chromaticity diagram:

μ=|O_{S}W|/|O_{S}A|=(x₂. y₁−y₂. x₁)/(x_{A}.(y₁−y₂)−y_{A}.(x₁−x₂))

λ=(x₂−μ. x_{A})/(x₂−x₁) or equivalently

λ=(y₂−μ. y_{A})/(y₂−y₁)

For the specific case where (x_{A}*(y₂−y₁)−y_{A}*(x₂−x₁)) is strictly equal to 0, μ is set to a very high value (for instance 999999.).

A monotonic increasing function ρ1(.) is then used to move the first 2D point A so that it belongs to the representation of the TCG by taking into account the 2D intersection point W.

According to a variant, the monotonic increasing function ρ1(.) is defined in order that each mapped color image data corresponds to at most one color image data.

This leads to an invertible color gamut mapping, i.e. each mapped color image data corresponds to at most one color image data. This is advantageous because this ensures that the colors of the OCG (original) could be retrieved from the mapped colors.

According to an embodiment, illustrated in FIG. 13a, an invertible color gamut mapping is determined as follows:

Let S be a 2D point determined in the chromaticity diagram by projecting the first 2D point A on a border of the representation of the TCG along the line (O_{S}W), and P be a 2D point determined in the chromaticity diagram by projecting the first 2D point A on a border of the representation of the PCG along the line (O_{S}W).

Moving the first 2D point A so that it belongs to the representation of the TCG is then to keep the 2D point P unchanged, and to move the 2D intersection point W toward the 2D point S.

The moved first 2D point A, i.e. the 2D point B belonging to the representation of the TCG and representative of the mapped color image data in the chromaticity diagram, is thus obtained as follows when the 2D intersection point W is the reference point:

O_{S}B=O_{S}W. ρ1(|O_{S}A|/|O_{S}W|)=O_{S}W. ρ1(1/μ) (3)

where the monotonic increasing function ρ1(.) satisfies the following conditions:

O_{S}S=O_{S}W. ρ1(|O_{S}W|/|O_{S}W|)

O_{S}P=O_{S}W. ρ1(|O_{S}P|/|O_{S}W|)

The conditions may be equivalently expressed by:

ρ1(|O_{S}W|/|O_{S}W|)=|O_{S}S|/|O_{S}W|

ρ1(|O_{S}P|/|O_{S}W|)=|O_{S}P|/|O_{S}W|

or more simply by:

ρ1(1)=1/f_{W}

ρ1(f_{P}/f_{W})=f_{P}/f_{W}

because by definition, O_{S}P=f_{P}. O_{S}S and O_{S}W=f_{W}. O_{S}S and equivalently |O_{S}P|=f_{P}. |O_{S}S| and |O_{S}W|=f_{W}. |O_{S}S|

For instance, the model of the monotonic increasing function ρ1(.) is given by:

ρ1(r)=u.r+v

with u=(1−f_{P})/(f_{W}−f_{P}) and v=1/f_{W}−u.

FIG. 13b depicts an example of a monotonic increasing function ρ1(.)

According to another example, the model of the monotonic increasing function ρ1(.) is given by:

ρ1(r)=u.log(r)+v

with u=(f_{P}−1)/(f_{W}. log(f_{P}/f_{W})) and v=1/f_{W}

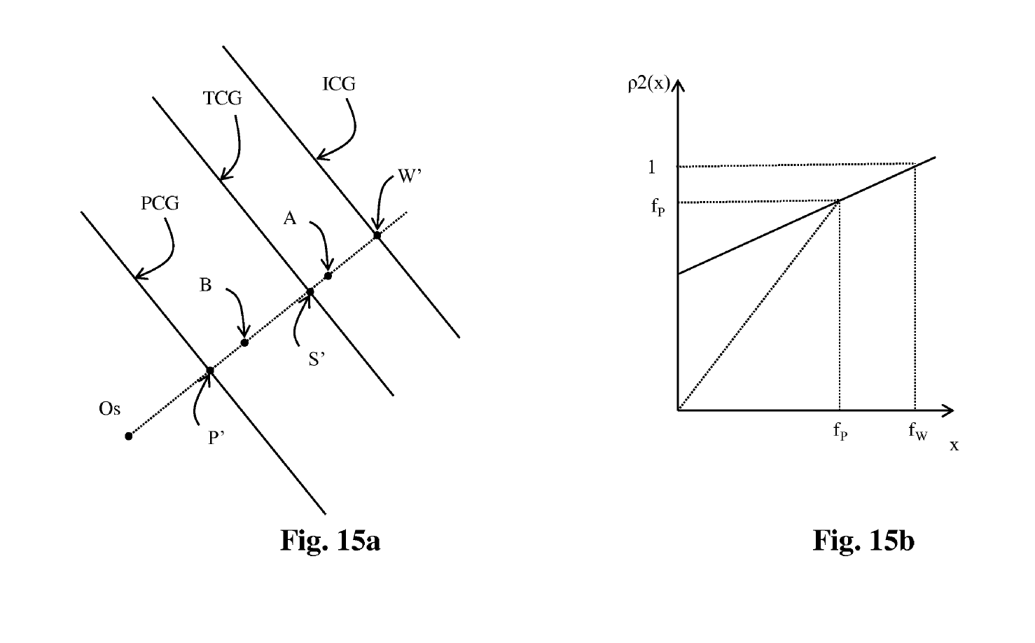

According to an embodiment of step 300, illustrated in FIGS. 15a-b, the first 2D point A is moved (shrunk) so that it belongs to the representation of the TCG as follows:

The first 2D point A is projected onto an intersection point S′ located on a border of a representation of the TCG.

According to an embodiment, an information data INFOTCG, that defines the border of representation of the TCG to be used, is obtained.

According to an embodiment, said information data INFOTCG defines the representation of TCG and the border of the representation of the TCG as follows: A border of the representation of the TCG is schematically represented by a line segment defined by two 2D points P′₁ and P′₂ representing two TCG color primaries in the chromaticity diagram. The position of the first 2D point A in the representation of the TCG in the chromaticity diagram is given by the weighted centroid definition:

O_{S}A=a′. O_{S}R_{T}+b′. O_{S}G_{T}+c′. O_{S}B_{T} with c′=1−a′−b′

where a′, b′, and c′ are weighting parameters, R_{T}(X_{RT},Y_{RT}), G_{T}(X_{GT},Y_{GT}) and B_{T}(X_{BT},Y_{BT}) are the three 2D points representing the three color primaries defining the TCG in the chromaticity diagram (FIG. 14).

This previous equation, expressed for the 2 coordinates x and y, gives the following 2 equations:

(x_{A}−x_{Os})=a′.(x_{RT}−x_{Os})+b′.(x_{GT}−x_{Os})+(1−a′−b′).(x_{BT}−x_{Os})

(y_{A}−y_{Os})=a′.(y_{RT}−y_{Os})+b′.(y_{GT}−y_{Os})+(1−a′−b′).(y_{BT}−y_{Os})

which leads to the following system, with a′ and b′ and unknown parameters:

(x_{RT}−x_{BT}). a′+(x_{GT}−x_{BT}). b′=(x_{A}−x_{BT})

(y_{RT}−y_{BT}). a′+(y_{GT}−y_{BT}). b′=(y_{A}−y_{BT})

Identifying a′ and b′ consists in solving this system of 2 equations with 2 unknowns.

Using the white point WP_{T} of the TCG instead of the centroid O_{S} would just consist in replacing in those equations O_{S} by WP_{T}.

The border of the representation of the TCG to which the 2D intersection point S′ belongs is then determined according to the values of the parameters a′, b′ and c′ as follows:
If the value of parameter a′ is the minimum value (compared to the value of b′ and c′, then the 2D intersection point S′ is located on the border of the representation of the TCG defined by P′₁=G_{T} and P′₂=B_{T};
If the value of parameter b′ is the minimum value (compared to the value of a′ and c′, then the 2D intersection point S′ is located on the border of the representation of the TCG defined by P′₁=R_{T} and P′₂=B_{T};
If the value of parameter c′ is the minimum value (compared to the value of a′ and b′, then the 2D intersection point S′ is located on the border of the representation of the TCG defined by P′₁=R_{T} and P′₂=G_{T}.

Once the border of the representation of the TCG has been determined, the position of the 2D intersection point S′ on this border (defined by the points P′₁ and P′₂) that corresponds to the intersection of line (O_{S}A) with the segment linking P′₁ and P′₂ is given by:

O_{S}S′=λ′. O_{S}P′₁+(1−λ′). O_{S}P′₂ (4)

where λ′ is a parameter value to be determined.

Moreover, the 2D intersection point S′ belongs to the line joining the 2D point A and the centroid O_{S}, i.e.

O_{S}S′=μ′.O_{S}A (5)

where λ′ is the distance ratio (real value) to be defined that is greater than 1.

Replacing O_{S}S′ in equation (5) leads to:

λ′. O_{S}P′₁+(1−λ′). O_{S}P′₂=μ′. O_{S}A

that is

λ′. P′₁P′₂+μ′. O_{S}A=O_{S}P′₂

In this process, to ease the computations, the coordinates (x_{A},y_{A}) relative to the 2D point A,(x₁, y₁) relative to the 2D point P′₁, (x₂, y₂) relative to the 2D point P′₂ are defined with O_{S} as origin. The equation can be developed for each coordinate x and y as follows:

λ′.(x₂−x₁)+μ′. x_{A}=x₂

λ′.(y₂−y₁)+μ′. y_{A}=y₂

λ′ and μ′ are then obtained by solving this system of two equations with two unknowns λ′ and μ′.

This gives the real values μ′ and λ′ and thus the projected 2D point intersection S′ on the determined border of the representation of the TCG in the chromaticity diagram:

μ′=|O_{S}S′|/|O_{S}A|=(x₂. y₁−y₂. x₁)/(x_{A}.(y₁−y₂)−y_{A}.(x₁−x₂))

λ′=(x₂−μ′. x_{A})/(x₂−x₁) or equivalently

λ′=(y₂−μ′. y_{A})/(y₂−y₁)

For the specific case where (x_{A}*(y₂−y₁)−y_{A}*(x₂−x₁)) is strictly equal to 0, μ′ is set to a very high value (for instance 999999.).

A monotonic increasing function ρ2(.) is then used to move the first 2D point A so that it belongs to the representation of the TCG by taking into account the 2D intersection point S′.

According to a variant, the monotonic increasing function ρ2(.) is defined in order that each mapped color image data corresponds to at most one color image data.

This leads to an invertible color gamut mapping, i.e. each mapped color image data corresponds to at most one color image data. This is advantageous because this ensures that the colors of the OCG (original) could be retrieved from the mapped colors.

According to an embodiment, illustrated in FIG. 15a, an invertible color gamut mapping is determined as follows:

Let W′ be a 2D point determined in the chromaticity diagram by projecting the first 2D point A on a border of the representation of the ICG along the line (O_{S}S′), and P′ be a 2D point determined in the chromaticity diagram by projecting the first 2D point A on a border of the representation of the PCG along the line (O_{S}S′).

Moving the first 2D point A so that it belongs to the representation of the TCG is then to keep the 2D point P′ unchanged, and to move the 2D point W′ toward the 2D intersection point S′.

The moved first 2D point A, i.e. the 2D point B belonging to the representation of the TCG and representative of the mapped color image data in the chromaticity diagram, is thus obtained as follows when the 2D intersection point S′ is the reference point:

O_{S}B=O_{S}S′. ρ2(|O_{S}A|/|O_{S}S′|)=O_{S}S′. ρ2(1/μ′) (6)

where the monotonic increasing function ρ2(.) satisfies the following conditions:

O_{S}S′=O_{S}S′. ρ2(|O_{S}W′|/|O_{S}S′|)

O_{S}P′=O_{S}S′. ρ2(|O_{S}P′|/|O_{S}S′|)

The conditions may be equivalently expressed by:

ρ2(|O_{S}W′|/|O_{S}S′|)=1

ρ2(|O_{S}P′|/|O_{S}S′|)=|O_{S}P′|/|O_{S}S′|

or more simply by:

ρ2(f_{W})=1

ρ2(f_{P})=f_{P}

because by definition, O_{S}P′=f_{P}. O_{S}S′ and O_{S}′=f_{W}. O_{S}S′ and equivalently |O_{S}P′|=f_{P}. |O_{S}S′| and |O_{S}W′|=f_{W}. |O_{S}S′|

For instance, the model of the monotonic increasing function ρ2(.) is given by:

ρ2(r)=u′.r+v′

with u′=(1−f_{P})/(f_{W}−f_{P}) and v′=1−u′ f_{W}.

FIG. 15b depicts an example of a monotonic increasing function ρ2(.)

According to another example, the model of the monotonic increasing function ρ2(.) is given by:

ρ2(r)=u′. log(r)+v′

with u′=(1−f_{P})/(log(f_{W})_log(f_{P}) and v=1−u′. log(f_{W}).

It shall be noted that in this embodiment, there is no explicit usage of the color primaries of PCG (2D points R_{P},G_{P},B_{P}) or ICG (2D points R_{I},G_{I},B_{I}). Advantageously, these color primaries do not need to be computed. Only the scaling factors f_{P} and f_{W} are required.

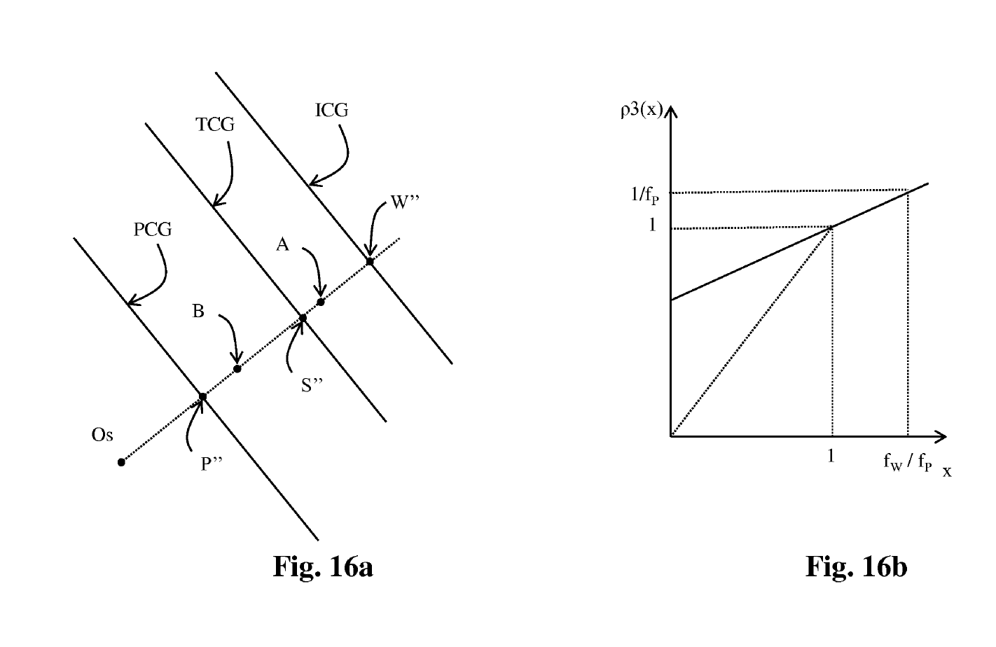

According to an embodiment of step 300, illustrated in FIGS. 16a-b, the first 2D point A is moved (shrunk) so that it belongs to the representation of the TCG as follows:

The first 2D point A is projected onto an intersection point P″ located on a border of a representation of the PCG.

A representation of the PCG in the chromaticity diagram (i.e. the color primaries R_{P}, G_{P}, B_{P} defining the PCG in the chromaticity diagram) is (are) obtained by applying on a representation of a Target Color Gamut TCG (on the color primaries of TCG) an homothety H with the scaling factor f_{P}.

According to an embodiment, an information data INFOPCG, that defines the border of representation of the PCG to be used, is obtained.

According to an embodiment, said information data INFOPCG defines the representation of PCG and the border of the representation of the PCG as follows: A border of the representation of the PCG is schematically represented by a line segment defined by two 2D points P″₁ and P″₂ representing two PCG color primaries in the chromaticity diagram. The position of the first 2D point A in the representation of the PCG in the chromaticity diagram is given by the weighted centroid definition:

O_{S}A=a″. O_{S}R_{P}+b″. O_{S}G_{P}+c″. O_{S}B_{P} with c″=1−a″−b″

where a″, b″, and c″ are weighting parameters, R_{P}(x_{RP},y_{RP}), G_{P}(X_{GP},Y_{GP}) and B_{P}(x_{BP},y_{BP}) are the three 2D points representing the three color primaries defining the PCG in the chromaticity diagram (FIG. 14).

This previous equation, expressed for the 2 coordinates x and y, gives the following 2 equations:

(x_{A}−x_{Os})=a″.(x_{RP}−x_{Os})+b″.(x_{GP}−x_{Os})+(1−a″−b″).(x_{BP}−x_{Os})

(y_{A}−y_{Os})=a″.(y_{RP}−y_{Os})+b″.(y_{GP}−y_{Os})+(1−a″−b″).(y_{BP}−y_{Os})

which leads to the following system, with a″ and b″ and unknown parameters:

(x_{RP}−x_{BP}). a″+(x_{GP}−x_{BP}). b″=(x_{A}−x_{BP})

(y_{RP}−y_{BP}). a″+(y_{GP}−y_{BP}). b″=(y_{A}−y_{BP})

Identifying a″ and b″ consists in solving this system of 2 equations with 2 unknowns.

Using the white point WP_{T} of the TCG instead of the centroid O_{S} would just consist in replacing in those equations O_{S} by WP_{T}.

The border of the representation of the PCG to which the 2D intersection point P″ belongs is then determined according to the values of the parameters a″, b″ and c″ as follows:
If the value of parameter a″ is the minimum value (compared to the value of b″ and c″, then the 2D intersection point P″ is located on the border of the representation of the PCG defined by P″₁=G_{P} and P″₂=B_{P};
If the value of parameter b″ is the minimum value (compared to the value of a″ and c″, then the 2D intersection point S′ is located on the border of the representation of the TCG defined by P′₁=R_{T} and P′₂=B_{T};
If the value of parameter c″ is the minimum value (compared to the value of a″ and b″, then the 2D intersection point P″ is located on the border of the representation of the PCG defined by P″₁=R_{P} and P″₂=G_{P}.

Once the border of the representation of the PCG has been determined, the position of the 2D intersection point P″ on this border (defined by the points P″₁ and P″₂) that corresponds to the intersection of line (O_{S}A) with the segment linking P″₁ and P″₂ is given by:

O_{S}P″=λ″. O_{S}P″₁+(1−λ″). O_{S}P″₂ (7)

where λ″ is a parameter value to be determined.

Moreover, the 2D intersection point P″ belongs to the line joining the 2D point A and the centroid O_{S}, i.e.

O_{S}P″=μ″. O_{S}A (8)

where μ″ is the distance ratio (real value) to be defined that is greater than 1.

Replacing O_{S}P″ in equation (8) leads to:

λ″. O_{S}P″₁+(1−λ″). O_{S}P″₂=μ″. O_{S}A

that is

λ″. P″₁P″₂+μ″. O_{S}A=O_{S}P″₂

In this process, to ease the computations, the coordinates (x_{A},y_{A}) relative to the 2D point A,(x₁, y₁) relative to the 2D point P″₁, (x₂, y₂) relative to the 2D point P″₂ are defined with O_{S} as origin. The equation can be developed for each coordinate x and y as follows:

λ″.(x₂−x₁)+μ″. x_{A}=x₂

λ″.(y₂−y₁)+μ″. y_{A}=y₂

λ″ and μ″ are then obtained by solving this system of two equations with two unknowns λ″ and μ″.

This gives the real values μ″ and λ″ and thus the projected 2D point intersection P″ on the determined border of the representation of the PCG in the chromaticity diagram:

μ″=|O_{S}P″|/|O_{S}A|=,(x₂. y₁−y₂. x₁)/(x_{A}.(y₁−y₂)−y_{A}.(x₁−x₂))

λ″=(x₂−μ″. x_{A})/(x₂−x₁) or equivalently

λ″=(y₂−μ″. y_{A})/(y₂−y₁)

For the specific case where (x_{A}*(y₂−y₁)−y_{A}*(x₂−x₁)) is strictly equal to 0, μ″ is set to a very high value (for instance 999999.).

A monotonic increasing function ρ3(.) is then used to move the first 2D point A so that it belongs to the representation of the TCG by taking into account the 2D intersection point P″.

According to a variant, the monotonic increasing function ρ3(.) is defined in order that each mapped color image data corresponds to at most one color image data.

This leads to an invertible color gamut mapping, i.e. each mapped color image data corresponds to at most one color image data. This is advantageous because this ensures that the colors of the OCG (original) could be retrieved from the mapped colors.

According to an embodiment, illustrated in FIG. 16a, an invertible color gamut mapping is determined as follows:

Let W″ be a 2D point determined in the chromaticity diagram by projecting the first 2D point A on a border of the representation of the ICG along the line (O_{S}P″), and S″ be a 2D point determined in the chromaticity diagram by projecting the first 2D point A on a border of the representation of the TCG along the line (O_{S}P′″).

Moving the first 2D point A so that it belongs to the representation of the TCG is then to keep the 2D intersection point P″ unchanged, and to move the 2D point W″ toward the 2D point S″.

The moved first 2D point A, i.e. the 2D point B belonging to the representation of the TCG and representative of the mapped color image data in the chromaticity diagram, is thus obtained as follows when the 2D intersection point P″ is the reference point:

O_{S}B=O_{S}P″. ρ3(|O_{S}A|/|O_{S}P″|)=O_{S}S″. ρ3(1/μ″) (9)

where the monotonic increasing function ρ3(.) satisfies the following conditions:

O_{S}S″=O_{S}P″. ρ3(|O_{S}W″|/|O_{S}P″|)

O_{S}P″=O_{S}P″. ρ3(|O_{S}P″|/|O_{S}P″|)

The conditions may be equivalently expressed by:

ρ3(|O_{S}W″|/|O_{S}P″|)=|O_{S}S″|/|O_{S}P″|

ρ3(|O_{S}P″|/|O_{S}P″|)=1

or more simply by:

ρ3(f_{W}/f_{P})=1/f_{P}

ρ3(1)=1

because by definition, O_{S}P″=f_{P}. O_{S}S″ and O_{S}W″=f_{W}.O_{S}S″ and equivalently |O_{S}P″|=f_{P}. |O_{S}S″| and |O_{S}W″|=f_{W}. |O_{S}S″|

For instance, the model of the monotonic increasing function ρ3(.) is given by:

ρ3(r)=u″.r+v″

with u″=(1−f_{P})/(f_{W}−f_{P}) and v″=1−u″ f_{W}.

FIG. 16b depicts an example of a monotonic increasing function ρ3(.)

According to another example, the model of the monotonic increasing function ρ3(.) is given by:

ρ3(r)=u″. log(r)+v″

with u″=(1/f_{P}−1)/(log(f_{W})_−log(f_{P}) and v=1 The scalar factors f_{P} and f_{W} are parameters that enable to control the color gamut mapping.

When the CIE 1931 xy chromaticity diagram is considered, a representation of the ICG in the chromaticity diagram is obtained from the representation of the TCG by:

O_{S}R_{W}=f_{W}. O_{S}R_{T} O_{S}G_{W}=f_{W}. O_{S}G_{T} O_{S}B_{W}=f_{W}. O_{S}B_{T}

where R_{W}, G_{W}, and B_{W} are three 2D points representing the three color primaries defining the ICG in the chromaticity diagram, R_{T}, G_{T}, and B_{T} are three 2D points representing the three color primaries defining the TCG in the chromaticity diagram, O_{S} is the center of the homothety. The process would apply similarly in any other color space such as CIE Lab (using the ab 2D coordinates system) or CIE Luv (using the uv 2D coordinates system).

According to an embodiment of the step 200, checking whether the first 2D point A is located outside the representation of the PCG in the chromaticity diagram comprises converting the three color components (r_{A},g_{A},b_{A}) of the first 2D point A (expressed in a given 3D RGB color space GCG) into the 3D RGB color space of the PCG. For instance, the GCG is the BT.2020 R,G and B color space. In another example, the GCG corresponds to the OCG. If one of the converted value is negative, this indicates that first 2D point A is outside the PCG. This is processed as follows:

Four 3×3 conversion matrices are considered: the conversion matrix M_{XYZ-to-PCG} for converting colors from the XYZ to PCG color space, the conversion matrix M_{XYZ-to-GCG} for converting colors from the XYZ to GCG color space, the conversion matrix M_{PCG-to-XYZ} for converting colors from the PCG to XYZ color space (inverse of M_{XYZ-to-PCG}), and the conversion matrix M_{GCG-to-XYZ} for converting colors from the GCG to XYZ color space (inverse of M_{XYZ-to-GCG}).The matrices M_{PCG-to-XYZ} and M_{GCG-to-XYZ} can be derived from the color primaries and white point defining the GCG and the PCG as detailed in the well-known SMPTE RP 177-1993 recommendation. Then the matrices M_{XYZ-to-PCG} and M_{XYZ-to-GCG} are simply the inverse of the matrices M_{PCG-to-XYZ} and M_{GCG-to-XYZ}.

Mathematically speaking, checking whether the first 2D point A is located outside the representation of the PCG in the chromaticity diagram may then be processed as follows.

Considering the color image data represented by the first 2D point A, is represented by three RGB coordinates (r_{A},g_{A},b_{A}) in the color space of the GCG, here a 3D RGB color space. Said color image data is converted to the color space of the PCG, here a 3D RGB color space, using the conversion matrix M_{GCG-to-PCG} that is a concatenation of the conversion matrices M_{XYZ-to-PCG}. M_{GCG-to-XYZ}:

$$[ \begin{matrix}{r}_{AP} \\ {g}_{AP} \\ {b}_{AP}\end{matrix} ] = {M}_{GCG \text{-} to \text{-} PCG} [ \begin{matrix}{r}_{A} \\ {g}_{A} \\ {b}_{A}\end{matrix} ]$$

where (r_{AP}, g_{AP}, b_{AP}) represents the converted color image data of the PCG.

Next, if any of the coordinates r_{AP}, g_{AP} or b_{AP} is negative then the first 2D point A is considered as being outside the PCG.

If, instead of being expressed in the 3D RGB color space of the GCG, the first point A has its three coordinates (X_{A},Y_{A},Z_{A}) expressed in the CIE 1931 XYZ color space, the said color image data is then converted to the PCG color space, here a RGB color space, using the conversion matrix M_{XYZ-to-PCG}:

$$[ \begin{matrix}{r}_{AP} \\ {g}_{AP} \\ {b}_{AP}\end{matrix} ] = {M}_{XYZ \text{-} to \text{-} PCG} [ \begin{matrix}{X}_{A} \\ {Y}_{A} \\ {Z}_{A}\end{matrix} ]$$

Then if any of the coordinates r_{AP}, g_{AP} or b_{AP} is negative then the first 2D point A is considered as being outside the PCG.

Advantageously, the scaling factor f_{W} is chosen sufficiently big in order to ensure that the OCG is fully included the ICG (as shown in FIG. 14).

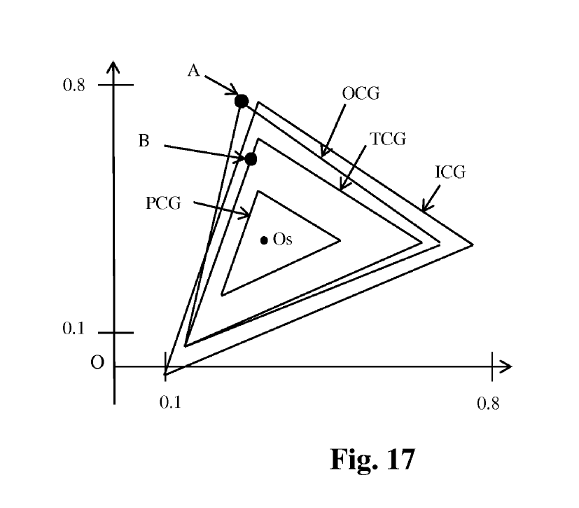

According to an embodiment, illustrated in FIG. 17, the colors of the OCG that do not belong to the ICG are clipped in order to belong to a border of the ICG. In other terms, when the 2D point A does not belong to the representation of the ICG, the 2D point A is forced to move on a border of the representation of the TCG in the chromaticity diagram.

Assuming the 2D point A is a vertex of the triangle representing the WCG in FIG. 17, is outside the triangle representing the ICG in the chromaticity diagram. Clipping the 2D point A means determining the second 2D point B as the intersection point between a line joining the first 2D point A and the centroid of the homothety H and a border of the representation of the TCG.

According to the embodiment described in relation with FIG. 13a-b, the clipping of 2D point A inside the ICG but outside the OCG can be simply applied by avoiding the real values (1/μ) (that is, the ratio |O_{S}A|/|O_{S}W|) to be larger than 1 before applying the function ρ1(.):
If 1/μ>1, 1/μ is set to 1,
Otherwise 1/μ is not modified

Indeed, if 1/μ=|O_{S}A|/|O_{S}W| is larger than 1, this means that |O_{S}A| is larger than |O_{S}W| so the 2D point A is above the ICG limits. Forcing 1/μ to 1 clips the point A to W.

Similarly, the clipping of 2D point A inside the ICG but outside the OCG can be simply applied by avoiding the real values 1/μ′ (that is, the ratio |O_{S}A|/|O_{S}S′|) to be larger than f_{W} before applying the function ρ1(.):

If 1/μ′>f_{W}, 1/μ′ is set to f_{W},

Otherwise 1/μ′ is not modified

Indeed, if 1/μ′=|O_{S}A|/|O_{S}S′| is larger than f_{W}, this means that |O_{S}A| is larger than (f_{W}. |O_{S}S′|) which is equal to |O_{S}W′| so the 2D point A is above the ICG limits. Forcing 1/μ′ to f_{W} clips the point A to W′.

Similarly, the clipping of 2D point A inside the ICG but outside the OCG can be simply applied by avoiding the real values 1/μ″ (that is, the ratio |O_{S}A|/|O_{S}P″|) to be larger than f_{W}/fₚ before applying the function ρ1(.):

If 1/μ″>f_{W}/fₚ, 1/μ″ is set to f_{W}/fₚ,

Otherwise 1/μ″ is not modified

Indeed, if 1/μ″=|O_{S}A|/|O_{S}P″| is larger than f_{W}/fₚ, this means that |O_{S}A| is larger than (f_{W}/f_{P}. |O_{S}P″|) which is equal to |O_{S}W″| so the 2D point A is above the ICG limits. Forcing 1/μ″ to f_{W}/fₚ clips the point A to W″.

According to another embodiment of the step 200, checking whether the first 2D point A is located outside the representation of the PCG in the chromaticity diagram consists in checking the value the ratio (|OA|/|OW|)|) that is 1/μ, as follows:

If (|OA|/|OW|)<=(|OP|/|OW|), then the point A is inside the PCG, otherwise the point A is outside the PCG. As by definition, |OP|/|OW|=f_{P}/f_{W}, the test consists is checking if (|OA|/|OW|)<=f_{P}/f_{W}.

Similarly, the test can be done by testing the ratio (|OA|/|OS|), that is 1/μ′ as follows:

If (|OA|/|OS|)<=(|OP|/|OS|)=f_{P}, then the point A is inside the PCG, otherwise the point A is outside the PCG.

Similarly, the test can be done by testing the ratio (|OA|/|OP|)|), that is 1/μ″ as follows:

If (|OA|/|OP|)<=(|OP|/|OP|)=1, then the point A is inside the PCG, otherwise the point A is outside the PCG.

According to another of its aspects, the disclosure further relates to an inverse color gamut mapping, i.e. the inverse of the color gamut mapping described in relation with the FIGS. 12-17.

In step 100 of FIG. 3, the module PCGM obtains a scaling factor f_{W} and a scaling factor fₚ of an homothety, as explained above.

In step 200 of FIG. 3, the module checks whether a 2D point B is located outside the representation of the PCG as explained above.

In step 310 of FIG. 3, when the 2D point B is located outside the representation of the PCG, a module ICAM moves the 2D point B so that it belongs to the representation of an intermediate color gamut ICG.

According to a first embodiment of step 310, the second 2D point B is moved (shrunk) so that it belongs to the representation of the ICG as follows:

The second 2D point B is projected onto an intersection point W located on a border of a representation of an intermediate color gamut ICG, said ICG being defined by applying on a representation of the TCG an homothety H with a scaling factor f_{W} strictly greater than 1.

According to an embodiment, an information data INFOICG, that defines the border of representation of the ICG to be used, is obtained.

According to an embodiment, said information data INFOICG defines the representation of ICG and the border of the representation of the ICG is defined as follows: A border of the or the representation of the ICG is schematically represented by a line segment defined by two 2D points P1 and P2 representing two color primaries in the chromaticity diagram. The position of the second 2D point B in the representation of the ICG in the chromaticity diagram is then given by:

O_{S}B=d. O_{S}R_{W}+e. O_{S}G_{W}+f. O_{S}B_{W} with f=1−d−e

where d, e, and f are weighting parameters that can be derived by resolving this equation in the xy coordinates system. Parameters d, e and f are derived is the same way as parameters a, b and c, using equations above.

The border of the representation of the ICG to which the 2D intersection point W belongs is then determined according to the values of the parameters d, e and f as explained above.

Once the border of the representation of the ICG has been determined, the position of the 2D intersection point W on this border (defined by the points P₁ and P₂) that corresponds to the intersection of line (O_{S}A) with the segment linking P₁ and P₂ is given by:

O_{S}W=λ. O_{S}P₁+(1−λ). O_{S}P₂

where λ is a parameter value to be determined.

This equation is actually identical to equation (1).

Moreover, the 2D intersection point W belongs to the line joining the second 2D point B and the centroid O_{S}, i.e.

O_{S}W=μ. O_{S}B

where μ is a real value to be defined that is greater than 1.

As achieved previously, solving these two last equations allows determining the real value p. and thus the 2D intersection point W, intersection of line (O_{S}A) with the determined border of the representation of the ICG in the chromaticity diagram:

μ=O_{S}W/O_{S}B=(x₂. y₁−y₂. x₁)/(x_{A}.(y₁−y₂)−y_{A}.(x₁−x₂))

where the coordinates B(x,y), P₁(x₁, y₁), P₂ (x₂, y₂) are defined with O_{S} as origin.

For the specific case where (x_{A}*(y₂−y₁)−y_{A}*(x₂−x₁)) is strictly equal to 0, μ is set to a very high value (for instance 999999.).The resolution is achieved as explained above.

A monotonic increasing function ρ1⁻¹(.) is used to move the second 2D point B so that it belongs to the representation of the representation of the ICG by taking into account the 2D intersection point W.

The monotonic increasing function ρ₁⁻¹(.) is the inverse of the monotonic increasing function ρ1(.)

O_{S}A=O_{S}W. ρ₁⁻¹(|O_{S}B|/|O_{S}W|)=O_{S}W. ρ₁⁻¹(1/μ)

where the monotonic increasing function ρ₁⁻¹(.) satisfies the following conditions:

O_{S}W=O_{S}W. ρ₁⁻¹(|O_{S}S|/|O_{S}W|)

O_{S}P=O_{S}W. ρ₁⁻¹(|O_{S}P|/|O_{S}W|)

The conditions may be equivalently expressed by:

ρ₁⁻¹(|O_{S}S|/|O_{S}W|)=|O_{S}W|/|O_{S}W|

ρ₁⁻¹(|O_{S}P|/|O_{S}W|)=|O_{S}P|/|O_{S}W|

or more simply by:

ρ₁⁻¹(1/f_{W})=1

ρ₁⁻¹(f_{P}/f_{W})=f_{P}/f_{W}

because by definition, O_{S}P=f_{P}. O_{S}S and O_{S}W=f_{W}.O_{S}S and equivalently |O_{S}P|=f_{P}. |O_{S}SI and |O_{S}W|=f_{W}. |O_{S}SI

For instance, the model of the monotonic increasing function ρ₁⁻¹(.) is given by:

ρ₁⁻¹(r)=u.r+v

with u=(f_{W}−f_{P})/(1−f_{P}) and v=1−u/f_{W}
According to another example, the model of the monotonic increasing function ρ₁⁻¹(.) is given by:

ρ₁⁻¹(r)=u.log(r)+v

with u=(f_{W}−f_{P})/f_{W}/log(1/f_{P}) and v=1+u.log(f_{W})

In this first embodiment of step 310, a 2D intersection point W positioned in a border of representation of the ICG is used to move the second 2D point B. Similarly as step 300, two other embodiments of step 310 can be defined, one using a 2D intersection point S′ positioned in a border of the representation of the TCG is used to move the second 2D point B, and another one using a 2D intersection point P″ positioned in a border of a representation of the PCG is used to move the second 2D point B.

According to an embodiment, the center of the homothety is either the white point of the target color gamut (TCG) or the centroid of the representation of the target color gamut (TCG) in the chromaticity diagram.

The gamut mapping preferably keeps the luminance Y unchanged when converting sample A to sample B: Y_{B}=Y_{A}. This involves the following equations:

X_{B}=x_{B}.Y_{A}/y_{B}

Y_{B}=y_{B}.Y_{A}/y_{B}=Y_{A}

Z_{B}=(1−x_{B}−y_{B}).Y_{A}/y_{B}

Similarly, the inverse gamut mapping preferably keeps the luminance Y unchanged when back-converting sample B to sample A: Y_{A}=Y_{B}. This involves the following equations:

X_{A}=x_{A}.Y_{B}/y_{A}

Y_{A}=y_{A}.Y_{B}/y_{A}=Y_{B}

Z_{A}=(1−x_{A}−y_{A}).Y_{B}/y_{A}

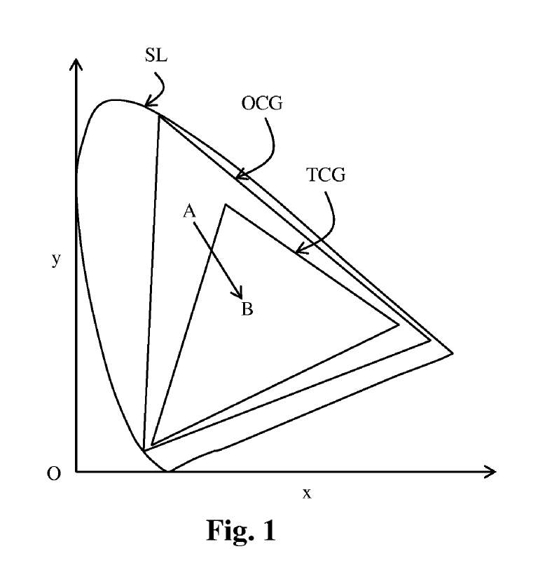

On FIG. 1-17, the modules are functional units, which may or not be in relation with distinguishable physical units. For example, these modules or some of them may be brought together in a unique component or circuit, or contribute to functionalities of a software. A contrario, some modules may potentially be composed of separate physical entities. The apparatus which are compatible with the disclosure are implemented using either pure hardware, for example using dedicated hardware such ASIC or FPGA or VLSI, respectively «Application Specific Integrated Circuit », «Field-Programmable Gate Array », «Very Large Scale Integration », or from several integrated electronic components embedded in a device or from a blend of hardware and software components.

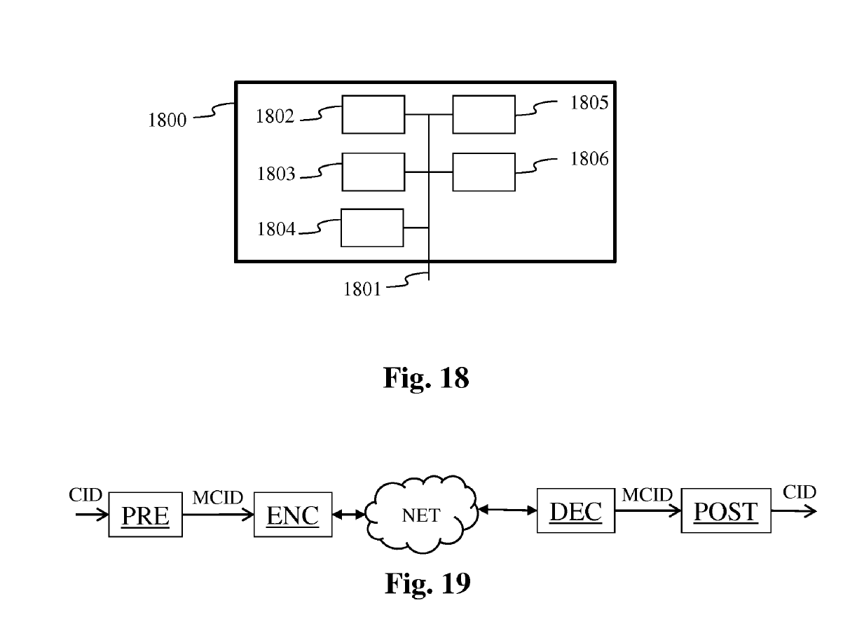

FIG. 18 represents an exemplary architecture of a device 1800 which may be configured to implement a method described in relation with FIG. 1-17.

Device 1800 comprises following elements that are linked together by a data and address bus 1801:
a microprocessor 1802 (or CPU), which is, for example, a DSP (or Digital Signal Processor);
a ROM (or Read Only Memory) 1803;
a RAM (or Random Access Memory) 1804;
an I/O interface 1005 for reception of data to transmit, from an application; and
a battery 1806.

According to a variant, the battery 1806 is external to the device. Each of these elements of FIG. 18 is well-known by those skilled in the art and won't be disclosed further. In each of mentioned memory, the word «register»used in the specification can correspond to area of small capacity (some bits) or to very large area (e.g. a whole program or large amount of received or decoded data). ROM 1803 comprises at least a program and parameters. Algorithm of the methods according to the disclosure is stored in the ROM 1803. When switched on, the CPU 1802 uploads the program in the RAM and executes the corresponding instructions.

RAM 1804 comprises, in a register, the program executed by the CPU 1802 and uploaded after switch on of the device 1800, input data in a register, intermediate data in different states of the method in a register, and other variables used for the execution of the method in a register.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

The present principles further relates to a method for encoding color image data, characterized in that the color image data are pre-processed according to a method described in relation with FIG. 2.

The present principles further relates to a method for decoding color image data, characterized in that the decoded color image data are post-processed according to a method described in relation with FIG. 3.

FIG. 19 shows schematically an encoding/decoding scheme in a transmission context between two remote devices A and B over a communication network NET, the device A comprises a processor in relation with memory RAM and ROM which are configured to implement a method for encoding a picture (or a sequence of picture) into a stream F and the device B comprises a processor in relation with memory RAM and ROM which are configured to implement a method for decoding a picture from a stream F.

The stream F may be carried by a digital or analog signal.

The encoding method comprises a pre-processing module PRE configured to implement a color gamut mapping, as described in relation with FIG. 2, of the color image data obtained from the picture (or each picture of a sequence of picture) to be encoded. The pre-processed color image data are then encoded by the encoder ENC. Said pre-processing may thus be used to adapt an original color gamut, e.g. a wide color gamut, e.g. BT. 2020, to a target color gamut, typically a standard color gamut such as BT. 709.

The decoding method comprises a module POST configured to implement an inverse color gamut mapping, as described in relation with FIG. 3, of decoded color image data obtained from a decoder DEC. Said post-processing method may be used to adapt the color gamut of the decoded picture to a target color gamut, typically a wide color gamut such as BT. 2020 or any other output color gamut adapted, for example to a display.

According to a variant of the disclosure, the network is a broadcast network, adapted to broadcast still pictures or video pictures from device A to decoding devices including the device B.

According to a specific embodiment, color image data at the encoding side and decoded color image data at the decoding side, are obtained from a source. For example, the source belongs to a set comprising:
a local memory (1803 or 1804), e.g. a video memory or a RAM (or Random Access Memory), a flash memory, a ROM (or Read Only Memory), a hard disk;
a storage interface (1805), e.g. an interface with a mass storage, a RAM, a flash memory, a ROM, an optical disc or a magnetic support;
a communication interface (1805), e.g. a wireline interface (for example a bus interface, a wide area network interface, a local area network interface) or a wireless interface (such as a IEEE 802.11 interface or a Bluetooth® interface); and
a picture capturing circuit (e.g. a sensor such as, for example, a CCD (or Charge-Coupled Device) or CMOS (or Complementary Metal-Oxide-Semiconductor)).

According to different embodiments, pre-processed or post-processed color image data are sent to a destination; specifically, the destination belongs to a set comprising:
a local memory (1803 or 1804), e.g. a video memory or a RAM, a flash memory, a hard disk;
a storage interface (1805), e.g. an interface with a mass storage, a RAM, a flash memory, a ROM, an optical disc or a magnetic support;
a communication interface (1805), e.g. a wireline interface (for example a bus interface (e.g. USB (or Universal Serial Bus)), a wide area network interface, a local area network interface, a HDMI (High Definition Multimedia Interface) interface) or a wireless interface (such as a IEEE 802.11 interface, WiFi® or a Bluetooth® interface); and
a display.

According to different embodiments of encoding or encoder, the stream F is sent to a destination. As an example, one of stream F is stored in a local or remote memory, e.g. a video memory (1804) or a RAM (1804), a hard disk (1003). In a variant, the stream F is sent to a storage interface (1005), e.g. an interface with a mass storage, a flash memory, ROM, an optical disc or a magnetic support and/or transmitted over a communication interface (1005), e.g. an interface to a point to point link, a communication bus, a point to multipoint link or a broadcast network.

According to different embodiments of decoding or decoder, the stream F is obtained from a source. Exemplarily, the stream F is read from a local memory, e.g. a video memory (1804), a RAM (1804), a ROM (1803), a flash memory (1803) or a hard disk (1803). In a variant, the bitstream is received from a storage interface (1805), e.g. an interface with a mass storage, a RAM, a ROM, a flash memory, an optical disc or a magnetic support and/or received from a communication interface (1805), e.g. an interface to a point to point link, a bus, a point to multipoint link or a broadcast network.

According to different embodiments, device 1800, being configured to implement an encoding method as described above, belongs to a set comprising:
a mobile device;
a communication device;
a game device;
a tablet (or tablet computer);
a laptop;
a still picture camera;
a video camera;
an encoding chip;
a still picture server; and
a video server (e.g. a broadcast server, a video-on-demand server or a web server).

According to different embodiments, device 1800, being configured to implement a decoding method as described above, belongs to a set comprising:
a mobile device;
a communication device;
a game device;
a set top box;
a TV set;
a tablet (or tablet computer);
a laptop;
a display and
a decoding chip.

The above method for processing color image data may be useful in an encoding/decoding scheme because a single stream may be generated at the encoding side for carrying a TCG version of a OCG picture and both the TCG and OCG version of said picture may be decoded and display according to the capabilities of the decoding.

As explained before, a PCG is chosen to preserve some original colors of the TCG. For instance setting f_{P} to 0.9 enables to preserve the colors in 90% of the TCG. Alternatively, if maintaining the colors of the mapped picture (that is the picture resulting from the color gamut mapping) is not essential, the PCG is chosen to limit the effects of rounding involved in the gamut mapping (if the process involves integer-based computations instead of float-point based computations). For instance setting f_{P} to a value close to 0.1 enables to get a higher precision in the gamut mapping and in its inverse process. An end-user may choose such PCG or the selection of the color primaries of the PCG may be deduced from studies of the human visual system.

Multiple PCG may be defined according to different targeted applications. For example it would be adapted to preserve some part of the wide color gamut when the mapped image color data are displayed on some specific display and it would be better to preserve some other parts of this wide color gamut when the mapped image data are displayed on display having different behavior.

In a transmission context as illustrated for example in FIG. 19, the inverse color gamut mapping is used at the decoding side. As described above, some embodiments of this method requires some parameters such as the scaling factors fₚ and f_{W}, and, potentially, an information data about the model of the monotonic increasing function to be used. Moreover, the inverse color gamut mapping requires also how the TCG, ICG, PCG have been defined at the encoding side. Such an information data (INFOICG, INFOTCG, INFOPCG).

All these parameters and information data may be stored locally by the decoding device or signaled in a stream or signal, for example the stream F, (embedded as metadata for example), in order to control the behavior of the inverse color gamut mapping at the decoding side.

According to an embodiment, those parameters are signaled either in an auxiliary stream such as a SEI message as defined by the HEVC standard (B. Bross, W. J. Han, J. R. Ohm, G. J. Sullivan, Y. K. Wang, T. Wiegand, “High Efficiency Video Coding (HEVC) text specification draft 10 (for FDIS & Last Call),” JCTVC-L1003, 12th JCT-VC meeting, Geneva, January 2013) or embedded in a syntax element of a main stream such as Sequence Parameter Set (SPS), Picture Parameter Set (PPS) or slice header as defined in the HEVC standard.

According to an embodiment, when the PCG parameters (INFOPCG) consist in three color primaries and a white point, that have to be inside the representation of the TCG in the chromaticity diagram, the following syntax is used:
preserved_color_gamut_primaries_x[i], i=0 to 2
preserved_color_gamut_primaries_y[i], i=0 to 2
preserved_color_gamut_white_point_x
preserved_color_gamut_white_point_y
   where ‘x’ and ‘y’ indicate the two coordinates of the 2D point in chromaticity diagram.

According to an embodiment, these points are specified in the CIE Lab color space.

According to another embodiment, the white point of the PCG is the same as the white point of the TCG.

According to another embodiment, the three color primaries of the PCG are defined from the three color primaries of the TCG and white point, using ratio factors ratio_i smaller than one. For a given TCG color primary SCPi (i=0 to 2) and from the TCG white point SWP, the corresponding PCG color primary PCPi is built such that:

PCPi_x−SWP_x=ratio_i*(SCPi_x−SWP_x)

PCPi_y−SWP_y=ratio_i*(SCPi_y−SWP_y)

The three ratio factors have to be signaled as metadata parameters. They can be constrained to be identical. In such a case only one ratio value has to be coded.

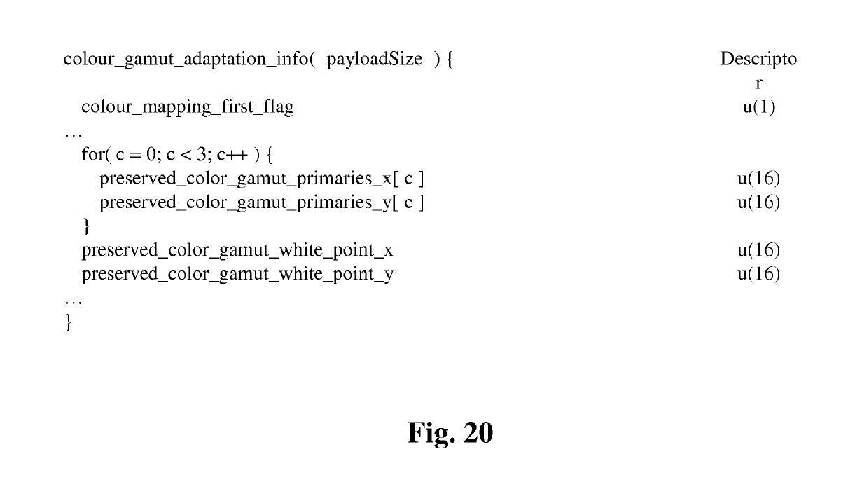

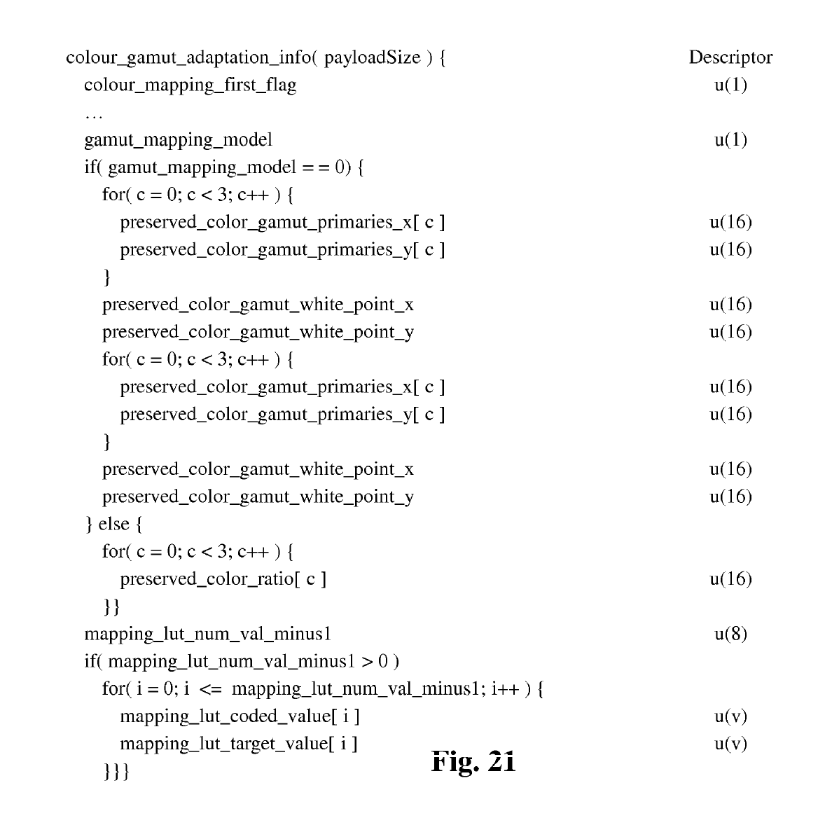

FIG. 20 shows an example of SEI message syntax that can be conveyed as metadata with a stream and that embeds parameters useful to perform the inverse color gamut mapping. The corresponding semantics is the following:
colour_mapping_first_flag specifies the order of the color mapping and dynamic range mapping operations for a current layer. When colour_mapping_first_flag is equal to 1, the color mapping applies before a dynamic range mapping. Otherwise the dynamic range mapping applies before the color mapping.
preserved_color_gamut_primaries_x[c] and preserved_color_gamut_primaries_y[c] specify the normalized x and y chromaticity coordinates, respectively, of the colour primary component c of the preserved color gamut in increments of 0.00002, according to the CIE 1931 definition of x and y as specified in ISO 11664-1 (see also ISO 11664-3 and CIE 15). It is suggested that index value c equal to 0 should correspond to the green primary, c equal to 1 should correspond to the blue primary, and c equal to 2 should correspond to the red colour primary. The values of preserved_color_gamut_primaries_x[c] and preserved_color_gamut_primaries_y[c] shall be in the range of 0 to 50 000, inclusive.
preserved_color_gamut_white_point_x and preserved_color_gamut_white_point_y specify the normalized x and y chromaticity coordinates, respectively, of the white point of the preserved color gamut in normalized increments of 0.00002, according to the CIE 1931 definition of x and y as specified in ISO 11664-1 (see also ISO 11664-3 and CIE 15). The values of preserved_color_gamut_white_point_x and preserved_color_gamut_white_point_y shall be in the range of 0 to 50 000.

According to an embodiment, the parameters required for defining the PCG, e.g., the PCG primaries coordinates, the scaling factors f_{P}, are non-scalar, and correspond to one-dimension functions that depend on the luminance (also called brightness) or luma value, Y.

According to an embodiment, each function is implemented as a 1D-look-up-table that depends of the value Y as input.

According to an embodiment, the 1D look-up-table are signaled as metadata.

According to an embodiment, each function is implemented as a piece-wise linear model that depends on Y as input.

According to an embodiment, each function is implemented as a piece-wise polynomial model that depends on Y as input.

According to an embodiment, the parameters of the piece-wise linear or polynomial model are signaled as metadata.

According to an embodiment, similar non-scalar parameters are signaled for the TCG.

According to an embodiment, similar non-scalar parameters are signaled for the ICG.

According to an embodiment, information data about the model of the monotonic increasing function to be used at the decoder, ρ₁⁻¹ (or ρ₂⁻¹ or ρ₃⁻¹), is transmitted as a mono-dimension look-up-table.

According to an embodiment this function is modeled by a piece-wise linear model, whose parameters are transmitted as metadata.

According to an embodiment this function is modeled by a piece-wise polynomial model, whose parameters are transmitted as metadata.

FIG. 21 provides another example of SEI message syntax that can be conveyed as metadata with a stream and that embeds parameters useful at the decoder side to perform the method for processing color image data and more precisely to perform the inverse color gamut mapping.

The semantics of colour_mapping_first_flag, preserved_color_gamut_primaries_x, preserved_color_gamut_primaries_y, preserved_color_gamut_white_point_x, and preserved_color_gamut_white_point_y is the same as described above.

Other elements semantics is defined as follows:
gamut_mapping_model is a parameter that enables to indicate the way the primaries of the PCG are derived; if gamut_mapping_model is equal to 0, the primaries coordinates are explicitly coded; if gamut_mapping_model is not equal to 0 (e.g. equal to 1), the scaling factor fₚ is coded and the primaries are deduced from this factor.
preserved_color_ratio corresponds to the scaling factor fₚ
   Similar parameters can be transmitted for the TCG and for the ICG.
mapping_lut_num_val_minus1 relates to the number of pivot points of the piece-wise model for the monotonic increasing function to be used at the decoder, ρ₁⁻¹ (or ρ₂⁻¹ or ρ₃⁻¹),
mapping_lut_coded_value[i] is a 1D array that gives the input values of the pivot points of the piece-wise model for the monotonic increasing function to be used at the decoder, ρ₁⁻¹ (or ρ₂⁻¹ or ρ₃⁻¹),
mapping_lut_target_value[i] is a 1D array that gives the output values of the pivot points of the piece-wise model for the monotonic increasing function to be used at the decoder, ρ₁⁻¹ (or ρ₂⁻¹ or ρ₃⁻¹).

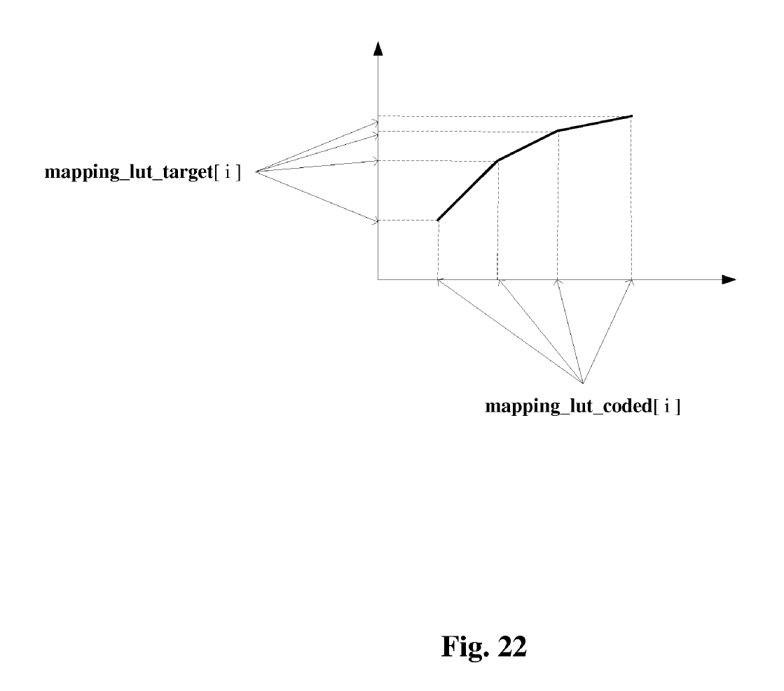

FIG. 22 illustrates these three parameters.

In FIG. 22, the parameter mapping_lut_num_val_minus1 is equal to 3 (4 pivot points).

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and any other device for processing a picture or a video or other communication devices. As should be clear, the equipment may be mobile and even installed in a mobile vehicle.

Additionally, the methods may be implemented by instructions being performed by a processor, and such instructions (and/or data values produced by an implementation) may be stored on a computer readable storage medium. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1-22. (canceled)

23. A method for processing color image data representing colors of an original color gamut (OCG), wherein the method comprises a color gamut mapping in the course of which a color image data (CID), represented by a first 2D point (A) belonging to a representation of the original color gamut in the chromaticity diagram xy of the CIE 1931 xyY color space, is mapped to a mapped color image data (MCID) belonging to a target color gamut (TCG), the mapped color image data belonging to the target color gamut (TCG) being represented by a second 2D point (B) belonging to a representation of the target color gamut (TCG) in the chromaticity diagram, wherein each color gamut is represented in the chromaticity diagram by a triangle defined by three 2D points representing three color primaries, wherein the color gamut mapping comprises:
obtaining a representation of a preserved color gamut (PCG) in the chromaticity diagram by a triangle defined by three 2D points representing three color primaries, wherein a first primary of the preserved color gamut is obtained by applying an homothety to said first primary either of the original color gamut or of the target color gamut by using a first scaling factor lower than one, wherein a second primary of the preserved color gamut is obtained by applying an homothety to said second primary either of the original color gamut or of the target color gamut by using a second scaling factor lower than one, wherein a third primary of the preserved color gamut is obtained by applying an homothety to said third primary either of the original color gamut or of the target color gamut by using a third scaling factor lower than or equal to one, wherein the center of said homothety is a centroid (C; O_{S});
checking if said first 2D point is located outside the representation of the preserved color gamut (PCG); and
when said first 2D point is located outside the representation of the preserved color gamut (PCG), moving said first 2D point (A) up to the second 2D point (B) along a line joining said centroid (C; O_{S}) and said first 2D point so that said second 2D point (B) belongs to the representation of the target color gamut (TCG) in the chromaticity diagram.

24. The method of claim 23, wherein said third scaling factor is equal to one and wherein each color gamut defined in the chromaticity diagram have a same third color primary in common, and wherein said centroid (C) is determined as being a 2D intersection point between a line joining a 2D point representing a first color primary of the original color gamut with a 2D point representing the corresponding first color primary of the target color gamut and a line joining a 2D point representing a second color primary of the original color gamut with a 2D point representing the corresponding second primary of the target color gamut.

25. The method of claim 23, wherein said centroid (Os) is given by OO_{S}=OR_{T}+OG_{T}+OB_{T}, where O is the origin of the chromaticity diagram, R_{T}, G_{T} and B_{T} are the 2D points representing respectively the first, second and third primaries of the target color gamut in the chromaticity diagram, and wherein the first, second and third scaling factors are equal.

26. The method of claim 23, wherein said centroid is the white point of the target color gamut, and wherein the first, second and third scaling factors are equal.

27. The method of claim 23, wherein checking if said first 2D point is located outside the representation of the preserved color gamut (PCG) comprises:
identifying which of the edges the representation of the target color gamut TCG, of the preserved color gamut PCG and of the original color gamut OCG, is the closest edge of the first 2D point;
determining an intersection 2D point between a line joining the first 2D point and the centroid and each identified edge;
the first 2D point is considered as being located outside the representation of the preserved color gamut (PCG) if the ratio (mP=|C I_{P}|/|C A|), defined by the distance separating the centroid C and the intersection 2D point I_{P} relative to the representation of the preserved color gamut (PCG) over the distance separating the centroid C and the first 2D point A, is lower than or equal to 1.

28. The method of claim 23, wherein said moving of the first 2D point up to the second 2D point uses a monotonic increasing function.

29. A method for processing color image data, comprising an inverse color gamut mapping in the course of which a mapped color image data, represented by a second 2D point belonging to a representation of a target color gamut in a chromaticity diagram, is inverse mapped to a color image data, the inverse mapped color data of the original color gamut being represented by a first 2D point belonging to a representation of the original color gamut in the chromaticity diagram, wherein the method further comprises:
obtaining a representation of a preserved color gamut (PCG) in the chromaticity diagram by applying an homothety either to the original color gamut or to the target color gamut;
checking if said second 2D point is located outside the outside the representation of the preserved color gamut (PCG); and
when said second 2D point is located outside the representation of the preserved color gamut (PCG), moving said second 2D point so that it belongs to the representation of the original color gamut (OCG), the first 2D point being then equal to the moved second 2D point.

30. The method of claim 29, wherein each color gamut being represented by a triangle defined by three 2D points representing three color primaries in a chromaticity diagram, each color gamut defined in such chromaticity diagram having a same color primary in common and wherein obtaining a representation of a preserved color gamut (PCG) in the chromaticity diagram comprises:
determining a centroid as being a 2D intersection point between a line joining a 2D point representing a first color primary of the original color gamut with a 2D point representing the corresponding first color primary of the target color gamut and a line joining a 2D point representing a second color primary of the original color gamut with a 2D point representing the corresponding second primary of the target color gamut;
obtaining a representation of a preserved color gamut in the chromaticity diagram by applying an homothety, the center of which is said determined centroid, to said first and second primaries either of the target color gamut or of the original color gamut by using at least one scaling factor lower than one.

31. The method of claim 30, wherein a first primary of the target color gamut is obtained by applying the homothety to a first primary either of the target color gamut or of the original color gamut by using a first scaling factor, and a second primary of the target color gamut is obtained by applying the homothety to a second primary either of the target color gamut or of the original color gamut by using a second scaling factor.

32. The method of claim 30, wherein checking if said second 2D point is located outside the representation of the preserved color gamut (PCG) comprises:
identifying which of the edges the representation of the target color gamut TCG, of the preserved color gamut PCG and of the original color gamut OCG, is the closest edge of the second 2D point;
determining an intersection 2D point between a line joining the second 2D point and the centroid and each identified edge;
the second 2D point is considered as being located outside the representation of the preserved color gamut (PCG) if the ratio, defined by the distance separating the centroid and the intersection 2D point relative to the representation of the preserved color gamut (PCG) over the distance separating the centroid and the second 2D point, is lower than or equal to 1.

33. The method of claim 30, wherein moving a second 2D point so that it belongs to the representation of the target color gamut (TCG) uses a monotonic increasing function.

34. The method of claim 30, wherein at least one of the scaling factor and/or the monotonic increasing function is obtained from an information data in a stream.

35. A device for processing color image data representing colors of an original color gamut (OCG), wherein the device comprises a color gamut mapper configured to map a color image data (CID), represented by a first 2D point (A) belonging to a representation of the original color gamut in a chromaticity diagram, to a mapped color image data (MCID) of a target color gamut (TCG), the mapped color image data of the target color gamut (TCG) being represented by a second 2D point (B) belonging to a representation of the target color gamut (TCG) in the chromaticity diagram, wherein the color gamut mapper is further configured to:
obtain a representation of a preserved color gamut (PCG) in the chromaticity diagram by applying an homothety either to the original color gamut or to the target color gamut;
check if said first 2D point is located outside the representation of the preserved color gamut (PCG); and
when said first 2D point is located outside the representation of the preserved color gamut (PCG), move said first 2D point so that it belongs to the representation of the target color gamut (TCG), the second 2D point being then equal to the moved first 2D point.

36. A device for processing color image data, comprising an inverse color gamut mapper configured to inverse-map a mapped color image data, represented by a second 2D point belonging to a representation of a target color gamut in a chromaticity diagram, to a color image data, the inverse mapped color data of the original color gamut being represented by a first 2D point belonging to a representation of the original color gamut in the chromaticity diagram, wherein the inverse color gamut mapper is further configured to:
obtain a representation of a preserved color gamut (PCG) in the chromaticity diagram by applying an homothety either to the original color gamut or to the target color gamut;
check if said second 2D point is located outside the outside the representation of the preserved color gamut (PCG); and
when said second 2D point is located outside the representation of the preserved color gamut (PCG), move said second 2D point so that it belongs to the representation of the original color gamut (OCG), the first 2D point being then equal to the moved second 2D point.

37. A method for encoding color image data, wherein the color image data are pre-processed according to the method of claim 23.

38. A method for decoding color image data, wherein the decoded color image data are post-processed according to the method of claim 29.

39. A device for encoding color image data, wherein it comprises a processor configured to implement the method of claim 23 to pre-process the color image data before encoding.

40. A device for decoding color image data, wherein it comprises a processor configured to implement a method of claim 29 to post-process the decoded color image data.

41. A computer program product comprising program code instructions to execute the steps of the method according to claim 23 when this program is executed on a computer.

42. A computer program product comprising program code instructions to execute the steps of the method according to claim 35 when this program is executed on a computer.

43. A computer program product comprising program code instructions to execute the steps of the method according to claim 36 when this program is executed on a computer.

44. Non-transitory storage medium carrying instructions of program code for executing steps of method according to claim 23 when said program is executed on a computing device.

45. A stream carrying encoded image data, wherein it further carries an information data indicating at least one scaling factor of an homothety used to obtain a representation of a preserved color gamut (PCG) in a chromaticity diagram from either to an original color gamut or to a target color gamut.

46. The stream of claim 45, wherein the stream further carries an information data indicating a monotonic function used to move a 2D point belonging to a representation of a color gamut in the chromaticity diagram a so that it belongs to the representation of another color gamut.
